(19) United States
(12) Patent Application Publication
(10) Pub. No.: US 2026/0270822 A1
(43) Pub. Date: Sep. 10, 2026

(54) Systems and Methods for Broadcasting Unsolicited Management Frames After a Channel Switch

(71) Applicant: Cisco Technology, Inc., San Jose, CA (US)

(72) Inventors: Brian Hart, Sunnyvale, CA (US); Binita Gupta, San Diego, CA (US); Vishal Satyendra Desai, San Jose, CA (US)

(21) Appl. No.: 19/553,011

(22) Filed: Feb. 27, 2026

Related U.S. Application Data
(60) Provisional application No. 63/767,155, filed on Mar. 5, 2025.

(51) Int. Cl. H04W 36/06; H04W 72/0453; H04W 72/30

(52) U.S. Cl. CPC H04W 36/06; H04W 72/0453; H04W 72/30

(57) ABSTRACT

Systems and methods for broadcasting unsolicited management frames after a channel switch in accordance with embodiments of the disclosure are described. A device, such as an access point, can determine to switch from a first channel to a second channel and calculate a max channel switch time. This time represents a delta between the last beacon transmit time on the first channel and the point of service readiness on the second channel. After switching at least one radio to the second channel and confirming physical or regulatory readiness, the network device can schedule an unsolicited management frame for immediate transmission. This frame, which may be an unsolicited probe response, notifies associated stations of availability before the next scheduled beacon interval. Stations can calculate their own ready times based on the signaled switch time to wake up and resume data transmission without performing a full re-association procedure, thereby reducing perceptible latency.

The present disclosure relates to wireless networking. More particularly, the present disclosure relates to providing clients with more predictable and lower-duration channel switching, including the ability to signal a channel switch time that is much less than a beacon interval or rather more than an integer multiple of beacon intervals.

### PRIORITY

This application claims the benefit of U.S. Provisional Patent Application No. 63/767,155, filed Mar. 5, 2025, which is incorporated by reference herein in its entirety.

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, 802.11ax, and 802.11be each offering improvements in speed, range, and efficiency. As well the maintenance projects of 802.11REVm, 802.11REVmb, 802.11REVmc, 802.11REVmd, 802.11REVme and 802.11REVmf have delivered (typically) more limited enhancements. Emerging technologies and future iterations continue to refine wireless networking standards, ensuring the evolution of efficient, reliable, and secure wireless communication.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual depiction of a communication layer architecture, in accordance with various embodiments of the disclosure;

FIG. 3 is a conceptual network diagram of various environments that a channel switch logic may operate on a plurality of network devices, in accordance with various embodiments of the disclosure;

FIG. 4 is a comparative timing diagram illustrating legacy and inventive channel switching behaviors, in accordance with various embodiments of the disclosure;

FIG. 5 is a diagram illustrating a max channel switch time element and (optional) extended capabilities element data structure, in accordance with various embodiments of the disclosure;

FIG. 6 is a flowchart showing a process for access point channel switching and immediate notification, in accordance with various embodiments of the disclosure;

FIG. 7 is a flowchart showing a process for access point regulatory checks and frame selection, in accordance with various embodiments of the disclosure;

FIG. 8 is a flowchart showing a process for handling client traffic after a channel switch, in accordance with various embodiments of the disclosure;

FIG. 9 is a flowchart showing a process for station wake up and synchronization function verification, in accordance with various embodiments of the disclosure; and

FIG. 10 is a conceptual block diagram of a device suitable for configuration with a channel switch logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DESCRIPTION OF EXAMPLE EMBODIMENTS

### OVERVIEW

In some embodiments, a wireless device includes a processor, a wireless interface configured to communicate with an access point, and a memory communicatively coupled to the processor, wherein the memory includes a channel switch logic. The logic is configured to receive, from the access point, a channel switch announcement indicating a switch from a first channel to a second channel, calculate a ready time for the second channel, transition the wireless interface to the second channel to wake up by or at the calculated ready time, receive an unsolicited management frame from the access point on the second channel, and resume data transmission without performing a re-association procedure.

In some embodiments, a method of efficient channel switching includes determining, by an access point, that a channel switch from a first channel to a second channel should occur, calculating, by the access point, a max channel switch time, transmitting a channel switch announcement, switching at least one radio of the access point to the second channel, and scheduling for transmission, by the access point, an unsolicited management frame on the second channel.

### EXAMPLE EMBODIMENTS

The necessity for efficient wireless communication has led to a requirement for more responsive frequency management in local area networks. Conventional channel switching methods often introduce significant delays because an access point typically waits until the next scheduled beacon interval to notify associated devices of its availability on a new frequency. This rigid adherence to legacy heartbeat schedules creates a period of dead time where stations remain in a doze or sleep state or idle, which can disrupt latency-sensitive applications like video conferencing or industrial controls. The present disclosure addresses these issues by providing a mechanism for immediate notification and precise timing that bypasses the traditional unnecessary waiting periods.

The embodiments described herein provide a technical solution by redefining how the duration of a channel transition is calculated and communicated across the network . Instead of pointing toward the next scheduled beacon, the system utilizes a max channel switch time that specifically indicates the moment an access point completes its hardware retuning/recalibration, corresponding software tasks and regulatory obligations . This calculation is based on a stable historical reference, such as the timing of the last beacon transmitted on the previous channel, to ensure all devices share a common temporal ground. By shifting the focus to actual service readiness, in many cases the network can significantly reduce the window of inactivity during a frequency change.

Central to this approach is the ability of an access point to schedule and transmit an unsolicited management frame immediately upon becoming ready for service on the second channel. This frame can take the form of an unsolicited probe response that contains the necessary connectivity metadata and, if needed, regulatory parameters required for stations to resume their data sessions. By broadcasting this information as soon as physical and any legal requirements are met, the access point provides a proactive signal that allows clients to reconnect far sooner than they would under a standard beacon schedule. This immediate notification ensures that the transition is reduced to very close to the minimum practical pause.

On the client side, in regard to an AP that the client knows that or has determined that the AP supports the upgraded signaling, wireless stations, particularly stations with regular QoS traffic, can leverage the enhanced timing elements to optimize their power consumption and wake up cycles. A station receives a channel switch announcement on the first frequency and extracts a precise ready time, allowing it to remain in a low power state for the duration of the AP’s hardware retuning. Once the calculated ready time is reached, the station activates its radio to listen for the immediate management frame on the new channel. This precision eliminates the need for the station to scan the medium blindly or wait for a legacy beacon, facilitating a much faster return to active data transmission. If the client side is unable to determine that the AP supports the upgraded signaling, the client, particularly a client with regular QoS traffic, might follow a more conservative tactic, of waking up and scanning the new channel up to a beacon interval before the determined ready time.

To maintain session integrity, the disclosure includes methods for verifying the continuity of the network state after the frequency transition is complete. The AP knows if its restarted the BSS, whereas its associated stations can evaluate the timing synchronization function to determine if a BSS stop and start (often called a restart or a reset or a flap) occurred during the switch. If the clock continues from the previous state, the devices can resume data traffic immediately without the overhead of a full re-association or fresh authentication. This validation step ensures that the speed of the channel switch does not come at the cost of security or connection stability, providing a more seamless experience for the end user.

Those skilled in the art will recognize that max channel switch time is a parameter that defines the duration a network device requires to move from one frequency to another, and includes some additional overheads. It acts as a countdown for associated stations to know exactly when to resume communication. This value is specifically tailored to account for the physical and regulatory delays of the implementation. By providing a precise window of time, the system assists devices, so they don’t need to wake up too early or stay idle for too long.

Those skilled in the art will recognize that max channel switch time is a parameter that defines the duration a network device requires to move from one frequency to another, and includes some additional overheads. It acts as a countdown for associated stations to know exactly when to resume communication. This value is specifically tailored to account for the physical and regulatory delays of the implementation. By providing a precise window of time, the system assists devices, so they don’t need to wake up too early or stay idle for too long.

In addition to this optimized timing, the system can be configured to support legacy clients that do not possess updated signaling capabilities. In some embodiments, the access point can advertise an unchanged max channel switch time that points to the specific time by which the next beacon is guaranteed to be transmitted. While legacy clients continue to work as usual by waiting for that indicated time, a next generation client expecting traffic can wake up exactly one beacon interval before that time to listen for an unsolicited probe response. Because the unsolicited probe response can appear at any point during that preceding beacon interval, the next generation client can receive the frame and immediately spring into action to start communication. This dual approach allows for backward compatibility while significantly reducing dead time for advanced devices.

In various embodiments, the calculation of this time is based on the delta between the last beacon sent on the old channel and the point of readiness on the new channel. This approach differs from legacy methods that rely on the next scheduled beacon interval. It allows the network to signal a transition period that may be significantly shorter than a standard heartbeat. The accuracy of this metric is essential for maintaining a more seamless link during frequency reconfigurations.

Often an unsolicited probe response can be understood as a management frame transmitted by an access point without being prompted by a specific request from a station. Unlike standard probe responses that react to a probe request sent as part of an active scan, this frame is sent proactively to broadcast network presence. It contains all the necessary operational data for a station to synchronize with the basic service set. This includes regulatory parameters as needed and frequency specific settings needed for immediate data resumption.

In some embodiments, the use of this frame is a primary mechanism for reducing perceived network latency after a channel switch. By broadcasting the frame as soon as the access point is ready for service, the system eliminates the need to wait for a beacon. Stations that receive this unsolicited notification can immediately verify the link status and start sending traffic. This proactive signaling is a departure from traditional passive discovery techniques used in wireless networking in relation to a channel switch.

Those skilled in the art will recognize that the point of service readiness can be signaled in several ways to accommodate different device generations. In one embodiment, the point of service readiness is the exact moment an unsolicited probe response is enqueued for transmission. In another embodiment, the signaling defines the time by which the access point will have transmitted the first beacon frame on the new channel. To maintain backward compatibility, a next-generation client can interpret this indicated beacon time as a deadline and choose to wake up one beacon interval or thereabouts beforehand to listen for an earlier unsolicited probe response. This allows the system to support legacy devices that wait for the beacon while enabling modern devices to resume data sessions much sooner.

In various embodiments, the timing synchronization function is a common clock maintained by all devices within a specific basic service set. It ensures that every station is aligned with the timing of the access point for some features such as in relation to frame scheduling and power management. For instance, the timing synchronization function can be utilized for the scheduling of beacon frames, restricted target wake time flows, and specific traffic specification or stream classification service flows. While some power management features do not rely on this clock, other features like scheduled automatic power save delivery and target wake time utilize the timing synchronization function for power management. The value is typically expressed in timing synchronization function ticks which provide a high resolution reference. Maintaining this clock can be important for the coordination of time sensitive data across the wireless medium.

Those skilled in the art will recognize that the continuity of this function is a key indicator of whether a network session survived a channel switch. If the clock continues to increment without resetting, the associated stations can stay connected without a new handshake. However, a reset in the clock indicates that the access point has restarted its internal state and has effectively forgotten the existence of the associated stations. In such a scenario, any traffic sent by a station will be dropped by the access point due to this ignorance, and the access point may sporadically transmit de-authentication or disassociation frames to notify the station of the situation. Detecting a reset in the clock allows non-AP stations to determine that a re-association is required to resolve this logical misalignment. This ensures that the station and the access point can re-establish a shared state and resume effective communication on the new channel.

In various embodiments, the wireless device comprises a processor and at least one network interface controller coupled to a memory. The memory comprises a channel switch logic that is communicatively coupled to the processor and is configured to notify at least one station of service availability on a second channel. The channel switch logic is further coupled to a storage containing timing data to ensure that an unsolicited management frame is scheduled for transmission prior to a next scheduled target beacon transmit time. In additional embodiments, the channel switch logic is configured to notify a network controller that it has moved to the second channel prior to resuming data traffic.

Furthermore, if the access point has restarted its internal state and reset its timing synchronization function, it may effectively lose all records of previously associated stations. In this state of ignorance, if a station attempts to transmit a message to the access point, the access point can detect the logical misalignment and transmit a de-authentication frame to that station. This notification from the access point, or the station's own detection of a restarted timing synchronization function, forces the station to perform a fresh authentication. This process ensures that the station and the access point can re-establish a valid connection and synchronize their logical states on the new channel.

In more embodiments, the wireless device is communicatively coupled to at least one second access point that is affiliated with the same multi-link device as the wireless device. The channel switch logic can transmit information regarding the channel switch on a third channel through the access point affiliated with the multi-link device to coordinate operations across the network. This coordination ensures that all devices affiliated with the multi-link architecture receive details regarding the frequency transition prior to the move. Because association occurs at the multi-link device level, if a station has an additional link established through an affiliated access point that is not undergoing a switch, the transition on the first channel does not necessarily interrupt the association.

By sharing data regarding the switch through an affiliated node, the device allows affiliated stations to use other links while connectivity is lost on the first channel and before connectivity can resume on the second channel. Furthermore, providing information regarding the switch through each affiliated interface allows for a more informed and seamless switch if the timing synchronization function remains stable, as the station can maintain its overall connection to the multi-link device even as one specific link reconfigures. The system can also utilize these affiliated links to broadcast regulatory constraints prior to the switch becoming active.

Aspects of the present disclosure may be embodied as an apparatus, a system, a method, or a computer program product. Accordingly, aspects of the present disclosure may take the form of an entirely hardware embodiment, inserted into a prior deployment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user’s computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

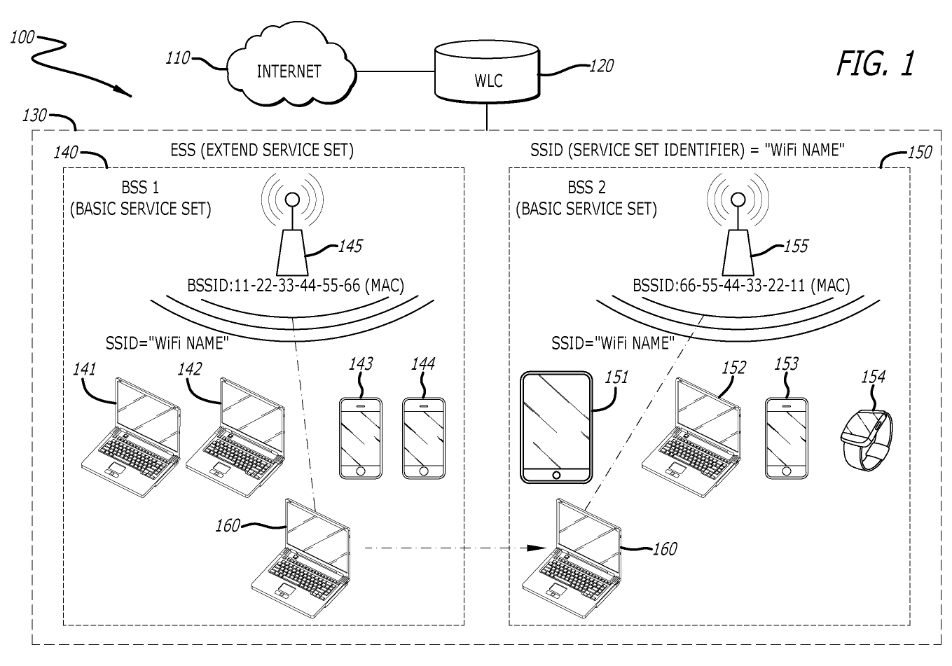

Referring to FIG. 1, a schematic block diagram of a wireless local networking system 100, in accordance with various embodiments of the disclosure is shown. Wireless local networking standards can play a crucial role in enabling seamless communication and connectivity between various devices within localized areas. One of the most prevalent standards can be Wi-Fi, which might be based on the Institute of Electrical and Electronics Engineers (IEEE) 802.11 family of protocols. As those skilled in the art recognize, Wi-Fi can provide high-speed wireless access to the internet and local network resources, with iterations such as 802.11a, 802.11b, 802.11g, 802.11n, 802.11ac, 802.11ax, and 802.11be each offering improvements in speed, range, and efficiency. As well the maintenance projects of 802.11REVm, 802.11REVmb, 802.11REVmc, 802.11REVmd, 802.11REVme and 802.11REVmf have delivered (typically) more limited enhancements. Emerging technologies and future iterations can continue to refine wireless networking standards, potentially ensuring the evolution of efficient, reliable, and secure wireless communication.

In the realm of IEEE 802.11 wireless local area networking standards, commonly associated with Wi-Fi technology, a service set can play a pivotal role in defining and organizing wireless network devices. A service set can essentially refer to a collection of wireless devices that might share a common service set identifier (SSID). The SSID, often recognizable to users as the network name presented in natural language, can serve as a means of identification and differentiation among various wireless networks. Within a service set, the nodes comprising devices like laptops, smartphones, or other Wi-Fi-enabled devices can operate collaboratively, potentially adhering to shared link-layer networking parameters. Essentially, a service set can form a cohesive and logical network segment, potentially creating an organized structure for wireless communication where devices can communicate and share data within the defined parameters, which might enhance the efficiency and coordination of wireless networking operations.

In the context of wireless local area networking standards, a service might be configured in two distinct forms, such as a basic service set or an extended service set. A basic service set can represent a subset within a service set, comprised of devices that might share common physical-layer medium access characteristics. These characteristics can include parameters such as radio frequency, modulation scheme, and security settings, which might ensure seamless wireless networking among the devices. The basic service set can be uniquely identified by a basic service set identifier (BSSID), which might be a 48-bit label adhering to Media Access Control (MAC) conventions. Despite the possibility of a device having multiple BSSIDs, each BSSID might typically be associated with, at most, one basic service set at any given time.

It can be noted that a basic service set might not be confused with the coverage area of an access point, which can be referred to as the basic service area (BSA). The BSA can encompass the physical space within which an access point might provide wireless coverage, while the basic service set can focus on the logical grouping of devices sharing common networking characteristics. This distinction can emphasize that the basic service set might be a conceptual grouping based on shared communication parameters, while the basic service area can define the spatial extent of an access point's wireless reach. Understanding these distinctions might be fundamental for effectively configuring and managing wireless networks, potentially ensuring optimal performance and coordination among connected devices.

The service set identifier (SSID) can define a service set or an extended service set. Normally it might be broadcast in the clear by stations in beacon frames to announce the presence of a network and can be seen by users as a wireless network name. Unlike basic service set identifiers, SSIDs can usually be customizable. Since the contents of an SSID field might be arbitrary, the IEEE 802.11 standard can permit devices to advertise the presence of a wireless network with beacons. A station can also likewise transmit a probe request in which the SSID field might be set to null (i.e., the wildcard SSID), which can prompt an associated access point to send the station one or more probe responses that characterize all the supported SSIDs of the AP.

In many embodiments, the internet 110 can be a public network connected to the wireless local networking system 100. The internet 110 can serve as a gateway to external data resources and services for various devices within the network. Access to the internet 110 might be facilitated through wired or wireless connections established by intermediate network controllers and access points. The internet 110 can represent a vast global network of interconnected computers that can exchange information using standardized communication protocols. Often, the internet 110 can provide the backhaul connectivity required for stations to communicate with remote servers or other networks.

In a number of embodiments, a wireless network controller 120 can be connected to a public network such as the internet 110. The wireless network controller 120 can be configured to manage a plurality of access points and their associated wireless parameters. Often, the wireless network controller 120 can handle centralized functions such as security authentication, radio resource management, and mobility control. The wireless network controller 120 can be in communication with an extended service set 130 to coordinate traffic flow across multiple network segments. In many embodiments, the wireless network controller 120 might be implemented as a physical appliance, a virtual machine, or a distributed logic within the network infrastructure. In other embodiments, there is no physical entity between the Internet and the APs, but some controller functions might be transferred to one AP and/or to an entity in the cloud (i.e., within the Internet).

In more embodiments, the extended service set 130 can be a sophisticated wireless network architecture designed to provide seamless coverage across a larger area. This extended service set 130 can span environments such as homes or offices that might be too expansive for reliable coverage by a single access point. The extended service set 130 can be created through the collaboration of multiple access points, potentially presenting itself to users as a unified and continuous network experience. By integrating one or more infrastructure basic service sets within a common logical network segment, the extended service set 130 might allow users to roam between different physical locations without losing connectivity. Overall, the extended service set 130 can provide a scalable and robust solution for ensuring comprehensive wireless coverage.

In additional embodiments, a first basic service set 140 can represent a subset of the extended service set 130. The first basic service set 140 can be comprised of a logical grouping of devices that might share common communication characteristics, such as radio frequency and security settings. Management of the first basic service set 140 can be performed by a dedicated access point to ensure efficient data transmission among its associated stations. In many embodiments, the first basic service set 140 can define a specific geographical area where wireless devices can interact with the network. The first basic service set 140 might be identified by a unique 48-bit identifier to distinguish it from other neighboring service sets.

In still more embodiments, a first notebook 141 can be a user end device that might connect to the first basic service set 140. The first notebook 141 can be configured with a wireless interface to communicate with an associated access point using standardized protocols. Often, the first notebook 141 can be utilized by a user to access local network resources or the internet 110. The first notebook 141 can transmit and receive data frames that might be processed by the wireless infrastructure. In certain situations, the first notebook 141 might enter a sleep state to conserve power while still remaining registered with the first basic service set 140.

In numerous embodiments, a second notebook 142 can be another mobile computing device associated with the first basic service set 140. The second notebook 142 might operate alongside other stations to exchange information across the wireless local networking system 100. Like other stations, the second notebook 142 can be assigned a unique Media Access Control address for identification within the network layers. The second notebook 142 can be configured to support various iterations of wireless standards to potentially achieve high-speed connectivity. In many embodiments, the second notebook 142 might be used for applications that require reliable and low-latency communication.

In some embodiments, a first phone 143 can be a cellular or mobile phone operating as a station within the first basic service set 140. The first phone 143 can facilitate wireless interaction with the network for a user while in a mobile environment. Often, the first phone 143 might be configured with a transceiver capable of handling both cellular and Wi-Fi signals. The first phone 143 can participate in the data exchange processes managed by the wireless local networking system 100. In many embodiments, the first phone 143 could potentially transition between different basic service sets as the user moves throughout a building.

In many embodiments, a second phone 144 can be another wireless communication device connected to the first basic service set 140. The second phone 144 can transmit management and data frames to an associated access point to maintain its network presence. Like other user end devices, the second phone 144 can be configured with specific Quality of Service parameters to prioritize different types of traffic. The second phone 144 might be capable of receiving channel switch announcements and adjusting its radio settings accordingly. In certain embodiments, the second phone 144 can be a smartphone or similar portable electronic device.

In various embodiments, a first access point 145 can be a wireless device configured to provide network access to stations within the first basic service set 140. The first access point 145 can bridge wireless traffic from associated devices to a larger wired or wireless network infrastructure. Often, the first access point 145 can broadcast beacon frames to announce the availability of the first basic service set 140 and its supported features. The first access point 145 can be configured to perform channel switches to avoid congestion or interference on its current operating frequency. In many embodiments, the first access point 145 might utilize the methods described in the present disclosure to minimize latency for stations during a channel transition.

In further embodiments, a second basic service set 150 can be another logical network segment within the extended service set 130. The second basic service set 150 can provide a separate environment for wireless devices to communicate using shared parameters. Management of the second basic service set 150 might be handled by an independent access point to coordinate medium access. Like other service sets, the second basic service set 150 can be configured with specific identifiers and security credentials to protect data integrity. In many embodiments, the second basic service set 150 can serve as a destination for roaming devices moving from the first network segment.

In additional embodiments, a first tablet 151 can be a portable computing device associated with the second basic service set 150. The first tablet 151 can use a wireless interface to interact with the networking infrastructure and access various services. Often, the first tablet 151 can be used for media consumption or productivity tasks that might require a stable wireless connection. The first tablet 151 can be configured to receive and parse information elements containing channel switch parameters. In many embodiments, the first tablet 151 might support advanced power-saving modes to potentially extend its operating time between charges.

In yet further embodiments, a fourth notebook 152 can be a computing station operating within the second basic service set 150. The fourth notebook 152 can transmit data to and receive data from an associated access point to facilitate communication with other network nodes. Like other notebooks in the wireless local networking system 100, the fourth notebook 152 can be configured with standardized protocols for link-layer interactions. The fourth notebook 152 can be identified within the second basic service set 150 by its unique hardware address. In numerous embodiments, the fourth notebook 152 might be a laptop computer or a similar workstation device.

In some embodiments, a third phone 153 can be a mobile device connected to the second basic service set 150. The third phone 153 can participate in the wireless communication environment by exchanging frames with the second access point 155. Often, the third phone 153 might be utilized for voice or video communication that can be sensitive to network latency. The third phone 153 can be configured to recognize signaling bits that indicate support for early notifications after a channel switch. In many embodiments, the third phone 153 can adjust its wake-up cycle based on the timing data provided by the access point.

In certain embodiments, a first watch 154 can be a wearable computing device that might connect to the second basic service set 150. The first watch 154 can represent a compact station with wireless capabilities for data synchronization and notification management. Due to its size and battery constraints, the first watch 154 might frequently utilize power-saving mechanisms to reduce its energy consumption. The first watch 154 can be configured to wake up at precise ready times to receive immediate management frames from the network infrastructure. In many embodiments, the first watch 154 might rely on accurate synchronization with the access point to maintain its connection.

In many embodiments, a second access point 155 can be a wireless gateway managing communication within the second basic service set 150. The second access point 155 can be in communication with the wireless network controller 120 to ensure cohesive operation across the extended service set 130. Often, the second access point 155 can transmit Unsolicited Probe Response frames to confirm its presence on a new channel immediately after a transition. The second access point 155 might be configured to perform regulatory checks, such as radar detection, before resuming service on restricted frequencies. In various embodiments, the second access point 155 can facilitate smooth roaming for devices transitioning from other network areas.

In additional embodiments, a third notebook 160 can be a station that might be communicatively connected to both the first basic service set 140 and the second basic service set 150. In this setup, the third notebook 160 can be seen to roam from the physical area serviced by the first basic service set 140 and into the physical area serviced by the second basic service set 150. This roaming capability can allow the third notebook 160 to maintain a continuous data session while moving through the coverage area of the extended service set 130. As the third notebook 160 moves, it might detect that the target access point has switched channels and can use the improved timing definitions to resume its traffic sooner. The third notebook 160 can potentially avoid significant data pauses by waking up earlier than the standard beacon interval.

Latency-sensitive traffic can be managed by prioritized scheduling and specialized management frames within the wireless local networking system 100. Access points, such as the first access point 145 and the second access point 155, can be configured to support protocols that might ensure deterministic communication for critical applications. When a channel switch occurs, the access point can calculate a max channel switch time based on its actual physical readiness rather than a rigid beacon schedule. This can allow stations like the first notebook 141 or the third notebook 160 to wake up and receive an Unsolicited Probe Response as soon as the access point is available. By utilizing these immediate management frames, the wireless local networking system 100 might effectively reduce perceptible lag during frequency reconfigurations.

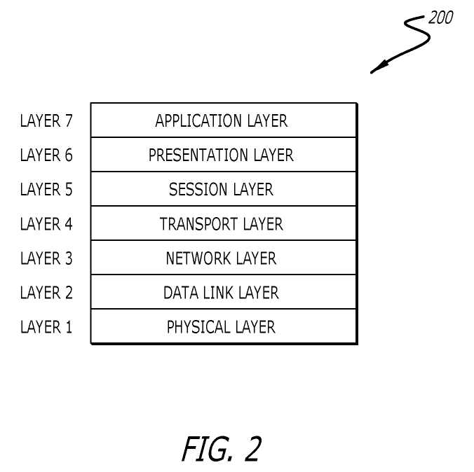

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. In many non-limiting examples, the wireless local networking system 100 can include a different number of service sets, access points, or stations than what is depicted. The elements depicted in FIG. 1 may also be interchangeable with other elements of FIGS. 2–10 as required to realize a particularly desired embodiment.

Referring to FIG. 2, a conceptual depiction of a communication layer architecture 200 in accordance with various embodiments of the disclosure is shown. In many embodiments, the communication layer architecture 200 can be utilized to carry out various communications described or required herein. In still more embodiments, the communication layer architecture 200 can be configured as the open systems interconnection model, which can be more commonly known as the OSI model. Likewise, the communication layer architecture 200 may have seven layers which may be implemented in accordance with the OSI model.

In the embodiment depicted in FIG. 2, the communication layer architecture 200 includes a first physical layer, which can serve as the foundational layer among the seven layers. It could be responsible for the transmission and reception of raw, unstructured data bits over a physical medium, such as cables or wireless connections. At this layer, the focus might be on the electrical, mechanical, and procedural characteristics of the hardware, including cables, connectors, and signaling. The primary goal may be to establish a reliable and efficient means of physically transmitting data between devices. The physical layer could not concern itself with the meaning or interpretation of the data; instead, it might concentrate on the fundamental aspects of transmitting binary information, addressing issues like voltage levels, data rates, and modulation techniques. Devices operating at the physical layer can include network cables, connectors, repeaters, and hubs. The physical layer's successful operation may be fundamental to the functioning of the entire OSI model, as it could form the bedrock upon which higher layers build their more complex communication protocols and structures.

In some embodiments, the communication layer architecture 200 can include a second data link layer which may be configured to be primarily concerned with the reliable and efficient transmission of data between directly connected devices over a particular physical medium. Its responsibilities might include framing data into frames, addressing, error detection, and, in some cases, error correction. The data link layer can be divided into two sublayers, such as a logical link control sublayer and a media access control sublayer. The logical link control sublayer may manage flow control and error checking, while the media access control sublayer might be responsible for addressing devices on the network and controlling access to the physical medium. Ethernet could be a common example of a data link layer protocol. This layer might ensure that data is transmitted without errors and can manage the flow of frames between devices on the same local network. Bridges and switches may operate at the data link layer, making forwarding decisions based on Media Access Control addresses. Overall, the data link layer might play a useful role in creating a reliable point to point or point to multipoint link for data transmission between neighboring network devices.

In various embodiments, the communication layer architecture 200 can include a third network layer which can be configured as a pivotal component responsible for the establishment of end to end communication across interconnected networks. Its primary functions might include logical addressing, routing, and the fragmentation and reassembly of data packets. The network layer may ensure that data is efficiently directed from the source to the destination, even when the devices are not directly connected. Internet protocol could be a prominent example of a network layer protocol. Devices known as routers can operate at this layer, making decisions on the optimal path for data to traverse through a network based on logical addressing. The network layer might abstract the underlying physical and data link layers, potentially allowing for a more scalable and flexible communication infrastructure. In essence, it can provide the necessary mechanisms for devices in different network segments to communicate, contributing to the end to end connectivity that may be fundamental to the functioning of the internet and other large scale networks.

In various embodiments, the communication for latency sensitive devices might typically occur on the data link layer and the network layer of the OSI model. At the data link layer, protocols like Ethernet and enhancements such as time sensitive networking could operate to provide deterministic delivery, low latency, and prioritization of traffic through mechanisms like quality of service and traffic shaping. Time sensitive networking, for example, may work within Ethernet to allocate specific time slots and prioritize frames for time critical data. At the network layer, protocols such as internet protocol can enable routing of packets between devices across different networks, while potentially ensuring that latency sensitive packets are given priority through mechanisms like differentiated services code point tagging. These layers might work together to establish a reliable communication path that meets the timing requirements of real time applications.

In additional embodiments, the fourth transport layer of the communication layer architecture 200 can be a critical element responsible for the end to end communication and reliable delivery of data between devices. Its primary objectives may include error detection and correction, flow control, and segmentation and reassembly of data. Two key transport layer protocols might be transmission control protocol and user datagram protocol. Transmission control protocol can ensure reliable and connection oriented communication by establishing and maintaining a connection between sender and receiver, and it could guarantee the orderly and error free delivery of data through mechanisms like acknowledgment and retransmission. User datagram protocol, on the other hand, may offer a connectionless and more lightweight approach suitable for applications where speed and real time communication might take precedence over reliability. The transport layer could shield the upper layer protocols from the complexities of the network and data link layers, providing a standardized interface for applications to send and receive data, making it a potentially useful facilitator for efficient, end to end communication in networked environments.

In further embodiments, a fifth session layer of the communication layer architecture 200 can be configured to play a pivotal role in managing and controlling communication sessions between applications. It might provide mechanisms for establishing, maintaining, and terminating dialogues or connections between devices. The session layer can help synchronize data exchange, which could ensure that information is sent and received in an orderly fashion. Additionally, it might support functions such as checkpointing, which could allow for the recovery of data in the event of a connection failure, and dialog control, which can manage the flow of information between applications. While the session layer may not be as explicitly implemented as lower layers, its services could be useful for maintaining the integrity and coherence of data during interactions between applications. By potentially managing the flow of data and establishing the context for communication sessions, the session layer can contribute to the overall reliability and efficiency of data exchange in networked environments.

In still more embodiments, the communication layer architecture 200 can include a sixth presentation layer, which may focus on the representation and translation of data between the application layer and the lower layers of the network stack. It could deal with issues related to data format conversion, which might ensure that information is presented in a standardized and understandable manner for both the sender and the receiver. The presentation layer may be responsible for tasks such as data encryption and compression, which could enhance the security and efficiency of data transmission. By handling the transformation of data formats and character sets, the presentation layer might facilitate seamless communication between applications running on different systems. This layer could then abstract the complexities of data representation, which may enable applications to exchange information without worrying about differences in data formats. In essence, the presentation layer can play a role in ensuring interoperability and data integrity between diverse systems and applications within a networked environment.

Finally, the communication layer architecture 200 can also comprise a seventh application layer which may serve as the interface between the network and the software applications that end users interact with. It can provide a platform independent environment for communication between diverse applications and could ensure that data exchange is meaningful and understandable. The application layer might encompass a variety of protocols and services that support functions such as file transfers, email, remote login, and web browsing. It could act as a mediator, potentially allowing different software applications to communicate seamlessly across a network. Some well-known application layer protocols may include hypertext transfer protocol, file transfer protocol, and simple mail transfer protocol. In essence, the application layer might enable the development of network aware applications by defining standard communication protocols and offering a set of services that can facilitate robust and efficient end to end communication across networks.

Although a specific embodiment for a communication layer architecture 200 is described above with respect to FIG. 2, any of a variety of systems and/or processes may be utilized in accordance with embodiments of the disclosure. For example, various aspects described herein could reside or be carried out on one layer, or a plurality of layers. The elements depicted in FIG. 2 may also be interchangeable with other elements of FIGS. 1 and 3–10 as required to realize a particularly desired embodiment.

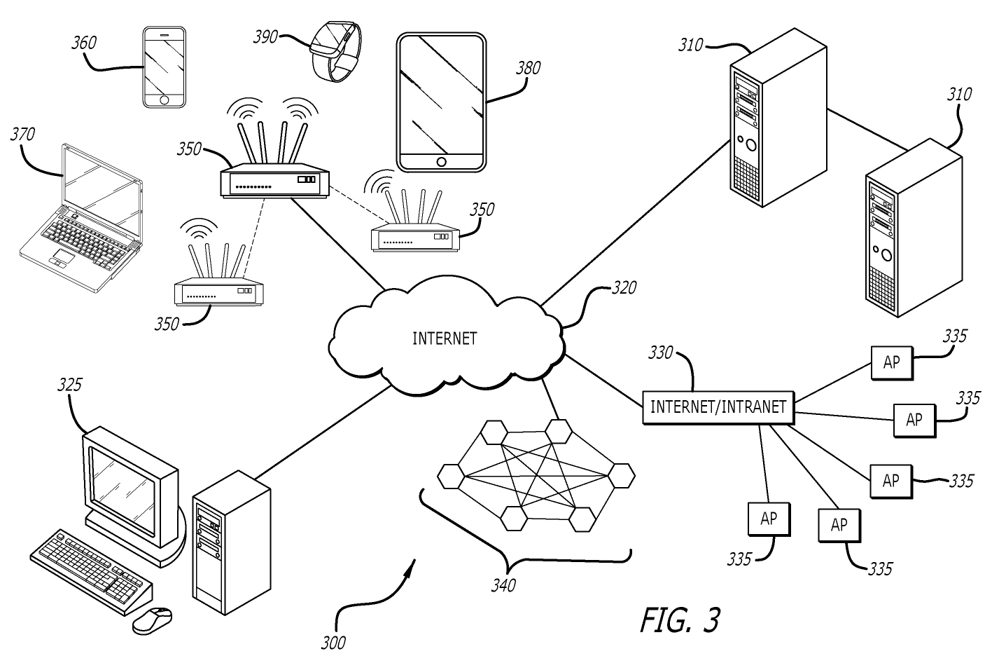

Referring to FIG. 3, a conceptual network diagram of various environments that a channel switch logic may operate on a plurality of network devices, in accordance with various embodiments of the disclosure is shown. This diagram illustrates how the functional logic of the disclosure can be deployed across a diverse range of hardware and software architectures to facilitate efficient wireless operations. The environments depicted highlight the flexibility of the channel switch logic to reside locally within a single device or be distributed across complex network structures. By visualizing these deployment scenarios, the diagram demonstrates how the technical solutions described herein can be scaled to meet different organizational or infrastructure needs.

In many embodiments, servers 310 can be configured with the channel switch logic or can otherwise operate to execute the processes described in the disclosure. The servers 310 can provide a centralized platform for managing channel switch operations across multiple remote sites or large campus environments. Often, the servers 310 can be part of a data center or a high performance computing cluster that processes large volumes of network telemetry. In certain situations, the servers 310 might host a cloud based network management tool that provides the channel switch logic as a service to various client devices.

In numerous embodiments, the Internet/Intranet 320 can serve as the backbone for connecting the various devices and environments described in the disclosure. The Internet/Intranet 320 can include a mix of wired and wireless technologies, such as fiber optics, ethernet cables, and cellular data links. This infrastructure allows the channel switch logic to exchange timing and regulatory data between devices regardless of their physical location. Often, the Internet/Intranet 320 is represented by the internet, providing the broad connectivity needed for remote management and updates.

In a number of embodiments, a personal computer 325 may be utilized to access and or manage various aspects of the channel switch logic, either remotely or within the local network itself. The personal computer 325 can provide a user interface for network administrators to monitor channel switch events and configure regulatory parameters. Often, the personal computer 325 can communicate over the Internet/Intranet 320 to interact with the logic residing on the servers 310 or other network nodes. In certain embodiments, the personal computer 325 might be used to manually trigger a channel switch or to view the duration of time saved by the inventive methods.

In further embodiments, a wireless LAN controller 330 may have an integrated channel switch logic that can be used to coordinate the behavior of multiple access points. As those skilled in the art will recognize, a wireless LAN controller 330 is often connected to various networking equipment within an intranet such as, but not limited to, switches routers, etc. FIG. 3 is simplified for explanatory purposes and is not meant to represent the only type of connections available. The wireless LAN controller can serve as a central intelligence point that decides when a channel switch is necessary based on radio resource management factors. By housing the channel switch logic, the wireless LAN controller 330 can ensure that all managed access points utilize consistent timing definitions during transitions. In many embodiments, the wireless LAN controller 330 might communicate with access points over a local area network to distribute updated synchronization data.

In additional embodiments, access points 335 can be connected to the wireless LAN controller 330 to provide wireless coverage for a specific environment. Each of the access points 335 can be configured to execute portions of the channel switch logic to perform physical radio retuning and channel availability checks. Often, the access points 335 transmit the channel switch announcements and unsolicited probe responses directly to associated stations. In various embodiments, the access points 335 might work in tandem with the wireless LAN controller 330 to minimize the latency experienced by clients during frequency reconfigurations.

In some embodiments, a deployed network 340 can represent a specific physical or logical environment where the channel switch logic is actively managing wireless traffic. The deployed network 340 can be a complex mesh network, an industrial ring network, or a traditional enterprise office layout. Within the deployed network 340, various sensors and controllers might rely on the channel switch logic to maintain deterministic communication links. In certain situations, the deployed network 340 can illustrate how the logic is implemented across a wide area to support mobility and seamless roaming.

In more embodiments, the network access points 350 can operate as the channel switch logic in a distributed manner or may have one specific device operate as the master logic for its neighbors. Each of the network access points 350 can connect directly to the Internet/Intranet 320, which can serve as networking equipment to provide a common communication path. The network access points 350 can communicate with one another through the Internet/Intranet 320 to synchronize channel switch events without the need for a separate controller. This distributed arrangement allows the channel switch logic to be highly resilient and scalable in decentralized environments. Often, the network access points 350 provide the immediate management frames that allow stations to wake up and resume data transmission earlier than standard beacon intervals.

In many embodiments, a cellular phone 360 can be a mobile computing device that interacts with the channel switch logic as a station. The cellular phone 360 can receive switch time parameters and calculate its own wake up schedule based on the ready time of the access point. Due to its mobile nature, the cellular phone 360 might frequently encounter channel switch events as it moves between different coverage areas. In various embodiments, the cellular phone 360 utilizes its own internal channel switch logic to verify synchronization data and resume data traffic without re association.

In additional embodiments, a laptop computer 370 can be another type of electronic device that connects to the network and benefits from the channel switch logic. The laptop computer 370 can be configured to support high bandwidth applications like video conferencing that are sensitive to data pauses. By interacting with the channel switch logic, the laptop computer 370 can avoid the long dead time gaps associated with legacy switching schedules. In certain situations, the laptop computer 370 might be used as a sniffer to detect and verify the transmission of unsolicited probe responses on a new channel.

In further embodiments, a portable tablet computer 380 can be a station device that relies on the channel switch logic for efficient power management and connectivity. The portable tablet computer 380 can use the switch time field to determine exactly when to wake its radio from a doze or sleep state. While the portable tablet computer 380 might observe an unchanged max channel switch time intended for legacy devices that points to the next guaranteed beacon transmission, it can be configured as a next-generation client to wake up one beacon interval before that indicated time. By waking up early, the portable tablet computer 380 can listen for an unsolicited probe response that could appear at any time during that preceding interval. Once the unsolicited probe response is received, the portable tablet computer 380 can immediately spring into action to start communication, allowing it to minimize power consumption while maintaining high quality of service for real-time traffic. In numerous embodiments, the portable tablet computer 380 might extract updated regulatory parameters from management frames transmitted by the distributed network logic to ensure compliant operation on the new channel.

In certain embodiments, a wearable computing device 390 can represent a compact network node that communicates with the network access points 350 or access points 335. The wearable computing device 390 often has significant battery and processing constraints, making the efficiency of the channel switch logic highly beneficial. By receiving immediate notifications after a switch, the wearable computing device 390 can stay in a low power state for the maximum possible duration. In many embodiments, the wearable computing device 390 uses the channel switch logic to conform to new regulations shortly after an access point completes its transition.

In certain embodiments, the various components can work together to facilitate a centralized channel switch. For example, a wireless LAN controller 330 can monitor the overall radio frequency environment and determine that access points 335 needs to switch to a new channel to avoid interference. The wireless LAN controller 330 can then use its integrated channel switch logic to calculate a precise ready time for one or more of the access points 335 based on their hardware retuning capabilities. Once calculated, this timing data can be sent to the access points 335, or multiple, which then broadcast the information to associated stations like the cellular phone 360 or laptop computer 370. This coordination allows the stations to synchronize their wake-up cycles and receive immediate unsolicited probe responses from the access points 335 as soon as it arrives on the new channel.

In many embodiments, the distributed components of the network can coordinate to maintain service continuity in a decentralized environment. For instance, network access points 350 can operate as a mesh where each node independently executes portions of the channel switch logic. If one of the network access points 350 detects an incumbent radar signal, it can immediately communicate this event to neighboring nodes through the Internet/Intranet 320. The neighboring nodes can then collaboratively select an alternate channel and update their internal switch time fields to reflect the added duration of the any necessary channel availability checks. Stations such as the portable tablet computer 380 can receive these updates from their associated AP of, in certain embodiments, from any node in the mesh, ensuring they have the correct information in when to resume data transmission without a lengthy pause.

In additional embodiments, the various environments can support remote management and verification of the switching process. For example, a network administrator can utilize a personal computer 325 to access a cloud-based management tool running on servers 310. The servers 310 can collect telemetry data from a deployed network 340 to calculate the actual duration of time saved by using immediate management frames instead of waiting for a legacy beacon schedule. If the switching performance in the deployed network 340 is suboptimal, the administrator can use the personal computer 325 to push updated regulatory data or configuration parameters to the channel switch logic of individual devices. This allows stations, including the wearable computing device 390, to benefit from optimized switching parameters even in remote or isolated network deployments.

Although a specific embodiment for various environments that a channel switch logic may operate on a plurality of network devices suitable for carrying out the various steps, processes, methods, and operations described herein is discussed with respect to FIG. 3, any of a variety of systems and or processes may be utilized in accordance with embodiments of the disclosure. For example, the channel switch logic may be deployed within a virtualized network function or as part of a software defined networking controller. The illustrated network nodes and devices represent a broad range of potential hardware implementations for the disclosed methods across diverse networking topologies. The elements depicted in FIG. 3 may also be interchangeable with other elements of FIGS. 1–2 and 4–10 as required to realize a particularly desired embodiment.

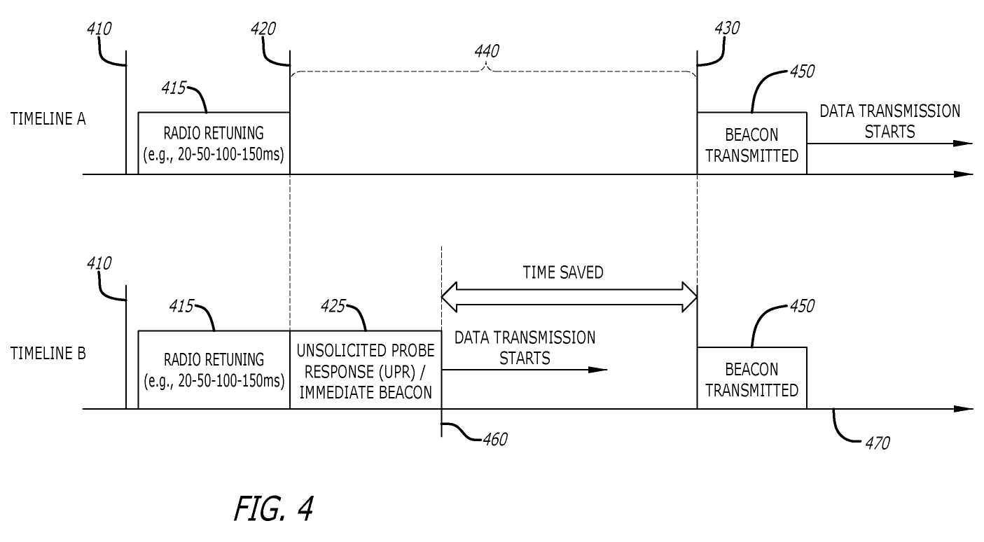

Referring to FIG. 4, a comparative timing diagram in accordance with various embodiments of the disclosure is shown. This diagram illustrates the differences in timing and latency between legacy channel switching behaviors and the improved methods described herein. The comparative timing diagram facilitates an understanding of how redefining the switch time parameters can lead to a more efficient use of network resources. By visually contrasting the two approaches, the diagram highlights the specific intervals where data transmission can be accelerated.

In many embodiments, the channel switch announcement 410 can indicate the beginning of a channel switch operation for both the legacy and inventive timelines. The channel switch announcement 410 can serve as a synchronization point for all associated stations to begin counting down to the start of the expected frequency change. Often, the channel switch announcement 410 is transmitted within a beacon frame or a specific management frame on the current operating channel. To ensure clarity in timing definitions, the channel switch announcement 410 can define a stable start reference point based on the scheduled time of the last beacon sent by the access point. It should be noted that this start reference point is distinct from the actual start time of the physical switch, as the start time typically occurs one beacon interval after the defined start reference. Consequently, the duration between the start reference and the beginning of the switch may not be to scale within FIG. 4 with the subsequent duration required to reach service readiness

In further embodiments, the radio retuning period 415 can represent the physical duration required for the software and/or hardware of an access point to tune to a different frequency. The radio retuning period 415 can vary in length depending on the specific radio architecture and the frequency band being accessed. In certain situations, the radio retuning period 415 might last between 20 and 50 milliseconds during a standard switch. The radio retuning period 415 can be significantly longer in more complex hardware configurations, potentially reaching up to 1200 milliseconds in certain high-performance serving radios.

In additional embodiments, the ready point 420 can designate the specific moment when the access point has finished retuning and is physically and/or procedurally prepared to transmit or receive data on the new channel. The ready point 420 can occur immediately following the completion of any necessary internal configuration or regulatory checks. In various embodiments, the ready point 420 can be utilized as the new end reference for calculating a more precise channel switch time. Identifying the ready point 420 can enable the access point to help clients to bypass the wait times associated with traditional beacon schedules.

In some embodiments, the notification frame 425 (shown in the embodiment of FIG. 4 as an unsolicited probe response (UPR)/immediate beacon) can be an unsolicited probe response or an immediate beacon (e.g., if the radio retuning function completed at or close to a scheduled beacon transmit time) transmitted by the access point upon reaching its ready state. The notification frame 425 can be scheduled for transmission immediately after the access point determines it is able to operate on the new channel or conditionally scheduled (e.g. UPR if not near a scheduled beacon time else a beacon). By transmitting the notification frame 425, the access point can proactively signal its availability to any awake stations. The notification frame 425 can include critical regulatory parameters and synchronization information to ensure the stations can resume data traffic without further delay.

In various embodiments, the scheduled target beacon transmit time 430 can represent the pre-defined instant where a beacon would normally be scheduled for transmission (its actual transmission time is subject to channel access delays) according to the standard TBTT scheduling behavior. The scheduled target beacon transmit time 430 can often occur many milliseconds after the access point has actually finished switching frequencies. In legacy systems, the scheduled target beacon transmit time 430 can act as a rigid barrier that prevents earlier communication. The scheduled target beacon transmit time 430 can be ignored or preempted by the inventive methods to reduce perceptible lag for time-sensitive applications.

In certain embodiments, the dead time interval 440 can illustrate the period of unnecessary latency found in legacy channel switching behaviors. As those skilled in the art will recognize, the unnecessary dead time in this process can be described as the dead time interval 440 minus the time for the notification frame 425 to occur. The dead time interval 440 can occur between the point when the access point is ready for service and the point when the next scheduled beacon is transmitted. During the dead time interval 440, the access point and stations might remain idle (e.g. dozing or in idle receive mode) despite the physical capability to communicate. The dead time interval 440 can be a major contributor to data pauses that negatively impact the quality of service for real-time video or voice traffic.

In many embodiments, the scheduled beacon 450 can be a standard management frame that is enqueued for transmission at a target beacon transmit time. The legacy countdown, which can be reported in the max channel switch time, can be set to reflect at least the duration until the target beacon transmit time is reached. The scheduled beacon 450 can be used by legacy stations to confirm the presence of the network device on the new channel. During the dead time interval preceding this frame, the access point might not transmit to clients because it can assume that the associated stations are not yet ready to receive transmissions on the new frequency. The scheduled beacon 450 can serve as the primary notification mechanism in instances where the early notification features described in this disclosure are not utilized.

In additional embodiments, the duration of time saved 460 can represent the specific reduction in latency achieved by transmitting a notification frame earlier than the legacy schedule. The duration of time saved 460 can be calculated as the difference between the scheduled beacon time and the actual or end of the transmission time of the unsolicited probe response. In some embodiments, the duration of time saved 460 can represent a significant portion of a beacon interval. The duration of time saved 460 can directly translate into a more responsive user experience during network reconfigurations.

In further embodiments, the inventive timeline 470 can illustrate the overall sequence of events that occur when the access point utilizes immediate notifications to resume service. The inventive timeline 470 can begin with the same switch announcement but can conclude much sooner than the legacy alternative. Along the inventive timeline 470, data transmission can start shortly after the radio retuning is complete. The inventive timeline 470 can demonstrate the benefit of decoupling the channel switch notification from the rigid beacon transmit schedule.

In certain embodiments, these elements can work together to provide a lower-duration channel switch. For example, the access point can transmit the channel switch announcement 410 to warn stations of an upcoming change. After the radio retuning period 415 completes, the access point can reach the ready point 420 and immediately transmit the notification frame 425. This sequence can allow stations to skip the dead time interval 440 and begin communicating before the scheduled target beacon transmit time 430 arrives.

In many embodiments, the coordination of these components can ensure regulatory compliance on a new channel. For instance, the access point can use the inventive timeline 470 to schedule a check for radar incumbents during the radio retuning period 415 (for instance if required by regulations for the new channel). Once the channel is confirmed to be clear at the ready point 420, the access point can construct the notification frame 425 with updated power control data. The access point can then broadcast this information to ensure the duration of time saved 460 is maximized while adhering to legal transmission requirements. This is particularly important if the AP’s first choice next channel is not suitable (e.g., due the presence of incumbent radar) and the AP checks a second (or more) channel(s) before finding a permissible new channel, since in this case the AP was not able to report the regulatory power limits beforehand (e.g., before the switch).

In additional embodiments , the various timing markers can facilitate improved power management for stations. A station can receive the channel switch announcement 410 and calculate when the network device will reach the ready point 420 based on a redefined switch time field. To accommodate legacy clients without requiring new signaling, the network device can advertise an unchanged max channel switch time within the channel switch announcement 410 that points to the time by which the scheduled beacon 450 is surely transmitted. While legacy clients can continue to operate as usual by waiting for this indicated time, a next generation station with traffic to transfer can be configured to wake up one beacon interval prior to that indicated time. The next generation station can then listen for the notification frame 425, which can appear any time in the preceding beacon interval or thereabouts. Once the notification frame 425 is received, the station can immediately spring into action to start communication and avoid the dead time interval 440. This precision can allow the station to efficiently resume data traffic and return to a sleep state sooner to conserve battery life.

Although a specific embodiment for a comparative timing diagram for carrying out the various steps, processes, methods, and operations described herein is discussed with respect to FIG. 4, any of a variety of systems and/or devices may be utilized in accordance with embodiments of the disclosure. For example, the timelines may include additional markers for multi-link operations or different frequency bands. The elements depicted in FIG. 4 may also be interchangeable with other elements of FIGS. 1–3 and 5–10 as required to realize a particularly desired embodiment.

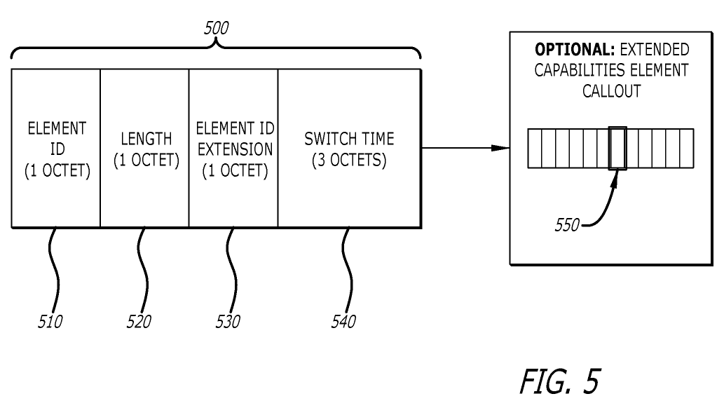

Referring to FIG. 5, a diagram of a max channel switch time element data structure in accordance with various embodiments of the disclosure is shown. This figure illustrates the arrangement of fields within an information element that an access point can use to communicate channel switching parameters to one or more associated stations. In certain embodiments, the data structure is designed to provide a stable reference for the start of a switch and an indication of the time by which the access point will have sent a beacon on the new channel. While this may represent a precise ready point in some embodiments, in other embodiments, it serves as a conservative deadline for legacy compatibility. By utilizing this format, the access point can effectively minimize data pause time, as a client can be configured to wake up one beacon interval or thereabouts before the indicated time to listen for an unsolicited probe response frame. Once the unsolicited probe response frame is received, which could occur at any moment during that preceding interval, the client can immediately resume communication rather than waiting for the full legacy countdown to expire.

The max channel switch time element serves as a comprehensive timing reference that spans the transition between frequencies. Because the element reports a delta from the target beacon transmit time of the last beacon on the old channel, it inherently includes at least one beacon interval of service before the switch actually begins. Furthermore, in some embodiments, the element can be configured to include up to one beacon interval or thereabouts of service after the switch is physically complete to account for the time until a first beacon is transmitted. This reporting structure ensures that all devices, regardless of whether they support immediate notifications, have a guaranteed window by which the access point will be available on the second channel.

In many embodiments, the element identification field 510 can serve as a unique label that distinguishes the current information element from other types of management frames. The element identification field 510 can allow a receiving station to correctly parse the subsequent data according to the specific rules for channel switch time elements. Often, the element identification field 510 is assigned a standardized value defined by a networking protocol or committee. The element identification field 510 can be configured with a size of exactly one octet to ensure compatibility with standard frame processing logic. For some elements, including the max channel switch time element, this is insufficient to identify the element, and the element is identified by the combination of the element identification field 510 and element identification extension field 530.

In certain embodiments, the length field 520 can indicate the total number of octets that follow the initial identification markers within the element. The length field 520 can be utilized by the networking logic of a station to determine the boundaries of the element structure. This field can help prevent errors during data reception by specifying exactly how much data should be read from the incoming stream. In various embodiments, the length field 520 is configured to have a size of one octet.

In more embodiments, the element identification extension field 530 can provide additional identification space for the information element beyond the element identification field 510. The element identification extension field 530 can be used to create the ability to identify more elements than can be identified by the element ID alone. This extension can allow for additional elements to be defined by the protocol without disrupting the existing framework of established network standards (element parsing). In some embodiments, the element identification extension field 530 comprises a one octet data block.

In additional embodiments, the switch time field 540 can store a numerical value representing the delta between a stable start reference and the moment the access point is ready for service, or a moment by which time the access point is ready for service almost surely . The value within the switch time field 540 can be calculated based on the target beacon transmit time of the last beacon frame transmitted on the old channel. In some embodiments, the signaling in the switch time field 540 remains unchanged from legacy definitions, while the operational behavior of the devices is modified to reduce dead time . For example, the access point can be configured to enqueue an unsolicited probe response for transmission immediately upon becoming ready for service, and a client can be configured to be ready for communication one beacon interval or thereabouts before the time indicated in the switch time field 540 to listen for that frame . In numerous embodiments, the switch time field 540 is configured with a size of three octets and expresses the time in timing units, where each timing unit is equal to one-thousand twenty-four timing synchronization function ticks or one-thousand twenty-four microseconds.

In some embodiments, the extended capabilities bit 550 can be an optional signaling flag included in a management frame to indicate support for immediate notifications or for the use of unsolicited probe response frames. The extended capabilities bit 550 can inform a station that the value provided in the switch time field 540 utilizes the refined readiness definition rather than the legacy beacon schedule. In other embodiments, this bit can indicate support for the consumption of unsolicited probe response frames by a client, where the client may need to be ready for communication ahead of the time indicated in the switch time field 540. The extended capabilities bit 550 might be transmitted by a network device and reserved for a client, transmitted by a client and reserved for a network device, or supported by both devices simultaneously . Often, the extended capabilities bit 550 is located at a specific bit position within an extended capabilities element of a beacon frame or a probe response.

In various embodiments, these components can work together to redefine how a channel switch is advertised across a network . For example, the access point can populate the switch time field 540 with a value that indicates readiness will occur significantly sooner than the next scheduled beacon. In some embodiments, the access point can signal support for making use of the unsolicited probe response frame via the extended capabilities bit 550, which informs the client it may need to be ready for communication one beacon interval or thereabouts ahead of the time indicated in the switch time field 540. The access point can simultaneously set the extended capabilities bit 550 to signal that this immediate notification or specialized frame consumption is supported. This combined data can allow a station to parse the length field 520, identify the element via the element identification field 510 and element identification extension field 530 if present, and successfully extract the early wakeup parameters.

In certain embodiments, the data structure can facilitate a seamless transition between different radio frequencies. For instance, if an access point lands on a channel requiring regulatory checks, it can use the switch time field 540 to account for the duration of the channel availability check. In some embodiments, the access point can signal support for the use of unsolicited probe response frames, notifying a client that it may need to be ready for communication one beacon interval or thereabouts before the time indicated in the switch time field 540. The element identification extension field 530 can indicate that the switch time field 540 includes this additional processing time. Awake stations can then use this information to synchronize their wake-up cycle with the point where the access point completes its legal compliance procedures or with the transmission of an unsolicited probe response frame that could appear at any moment during the preceding interval.

In many embodiments, the max channel switch time element 500 can be encapsulated within a larger management frame for transmission, such as a beacon or probe response. The access point can also insert the element into a channel switch announcement frame or an extended channel switch announcement frame prior to leaving the current operating frequency. This allows the associated stations to receive the element identification field 510, the element identification extension field 530, and the switch time field 540 while still maintaining a stable link. Once the stations have the switch time data, they can enter a doze or sleep state and rely on the timing provided by the data structure to re-establish the connection on the new channel. The stations can be configured to wake up at the appropriate time, which can be indicated by the max channel switch time in one embodiment, by the point at which an unsolicited probe response will have been transmitted in a second embodiment, or by the point at which a beacon will have been transmitted, such as one beacon interval or thereabouts before the indicated time, in a third embodiment.

Although a specific embodiment for a max channel switch time element data structure for carrying out the various steps, processes, methods, and operations described herein is discussed with respect to FIG. 5, any of a variety of systems and/or devices may be utilized in accordance with embodiments of the disclosure. For example, the data structure may be configured to include additional fields for specific regulatory domains or multi-link device parameters. The elements depicted in FIG. 5 may also be interchangeable with other elements of FIGS. 1–4 and 6–10 as required to realize a particularly desired embodiment.

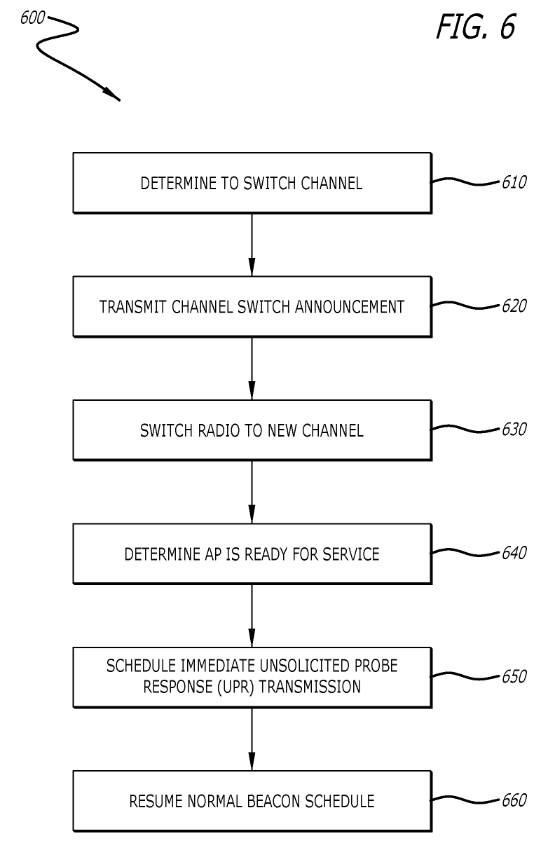

Referring to FIG. 6, a flowchart depicting a process 600 for access point channel switching and immediate notification in accordance with various embodiments of the disclosure is shown. The process 600 illustrates the logical operations performed by a network device to transition between frequencies while potentially reducing the time that associated stations remain in a disconnected or doze or sleep state. By proactively signaling availability on a new channel, the process 600 can maintain high quality of service for applications requiring low latency and consistent throughput.

In many embodiments, the process 600 can determine to switch channel (block 610). This determination might occur in response to the channel switch logic detecting a high level of co-channel interference or congestion on the current operating frequency. For example, the channel switch logic can monitor clear channel assessment metrics and decide to move to a less crowded band. Alternatively, the determination might be triggered by a management command received from a centralized wireless LAN controller or an automated radio resource management system. In a non-limiting example, the wireless LAN controller, given a radar detection by an AP, could order the access point to vacate the current channel immediately to ensure regulatory compliance. In some embodiments, the AP can vacate the current channel without waiting for the WLC (or in the absence of a WLC).

In a number of embodiments, the process 600 can transmit a channel switch announcement (block 620). The transmit channel switch announcement can be configured to include a max channel switch time element that reports the timing reference from the target beacon transmit time of the last beacon frame transmitted on the first channel. Because this element utilizes the last beacon as a baseline, it can include a beacon interval of service before the switch begins and, in certain embodiments, up to one beacon interval or thereabouts of service after the switch completes.

In various embodiments, the duration indicated by this element can represent the point where the switch ends, which can specifically correspond to when an unsolicited probe response is enqueued, the time by which the network device will have transmitted an unsolicited probe response, or the time by which the network device will have transmitted the first beacon frame on the second channel. For instance, the channel switch announcement can be broadcast within a beacon frame, probe response frame, or a specific action frame on the first channel to warn all associated stations of the move. It is contemplated that the announcement might also be transmitted on a secondary radio link if the device is part of a multi-link device architecture. For example, a multi-link device might use its other 2.4 and 6 GHz links to inform stations of an impending or ongoing switch on a 5 GHz link.

In more embodiments, the process 600 can switch radio to new channel (block 630). This physical transition might involve retuning the radio frequency circuitry and stabilizing the internal oscillators for operation on the second channel, along with any other hardware and/or software delays. In some embodiments, the switch radio to new channel can be completed in a duration ranging from 20 to 50 milliseconds. However, in other embodiments, the hardware might require a longer period of up to 1200 milliseconds to fully reconfigure the serving radio. It is contemplated that the radio might be switched while other radio interfaces on the same network device remain active and operational on different frequency bands.

In further embodiments, the process 600 can determine when the AP is ready for service (block 640). This determination can include verifying that the radio hardware has successfully locked onto the new center frequency and that the transmitter is ready to broadcast data. For instance, the channel switch logic can check the status of a frequency synthesizer or a baseband processor to confirm readiness, and that other hardware and/or software activities have completed. Additionally, the process 600 might perform a channel availability check to ensure the medium is clear of other transmissions or high-priority/incumbent signals. In a non-limiting example, the access point could listen for a specific period to ensure no radar signatures are detected before declaring that it is ready for service.

In additional embodiments, the process 600 can schedule an immediate unsolicited probe response transmission (block 650). The transmission of this unsolicited management frame can be scheduled to occur at the exact moment the access point is ready to operate on the second channel, which includes the completion of all related hardware and software activities and meeting legal requirements. For example, instead of waiting for the next target beacon transmit time, the channel switch logic can push the unsolicited probe response to the top of the transmission queue for immediate broadcast. This early notification provides a centralized mechanism for associated stations waiting to communicate with the access point during the radio retuning period. By proactively broadcasting the unsolicited probe response, which can contain updated regulatory parameters and synchronization data, the system prevents a large number of stations from simultaneously probing the access point. This centralized signaling allows clients to wait quietly until the access point indicates readiness, thereby reducing the likelihood of collisions and network congestion while allowing for a seamless resumption of data traffic.

In certain embodiments, the process 600 can resume a normal beacon schedule (block 660). Once the initial immediate notification has been sent, the access point can revert to its standard periodic scheduling for the transmission of management and synchronization information. This involves aligning subsequent transmissions with the established timing synchronization function of the basic service set without requiring adjustments to internal clocks. By maintaining this continuity, the access point ensures that the next scheduled beacon is sent at the expected interval relative to the last target beacon transmit time on the previous channel. While a number of embodiments may automatically resume the standard schedule, in other embodiments, such as those involving mobile access points or Wi-Fi Direct group owners, the access point might wait for a specific trigger or client request before returning to normal beaconing behavior.

Although a specific embodiment for a process 600 for access point channel switching and immediate notification for carrying out the various steps, processes, methods, and operations described herein is discussed with respect to FIG. 6, any of a variety of systems and/or devices may be utilized in accordance with embodiments of the disclosure. For example, the process 600 could be implemented within a virtualized access point running on a general-purpose server or as a dedicated function within a hardware-based network interface controller. The elements depicted in FIG. 6 may also be interchangeable with other elements of FIGS. 1–5 and 7–10 as required to realize a particularly desired embodiment.

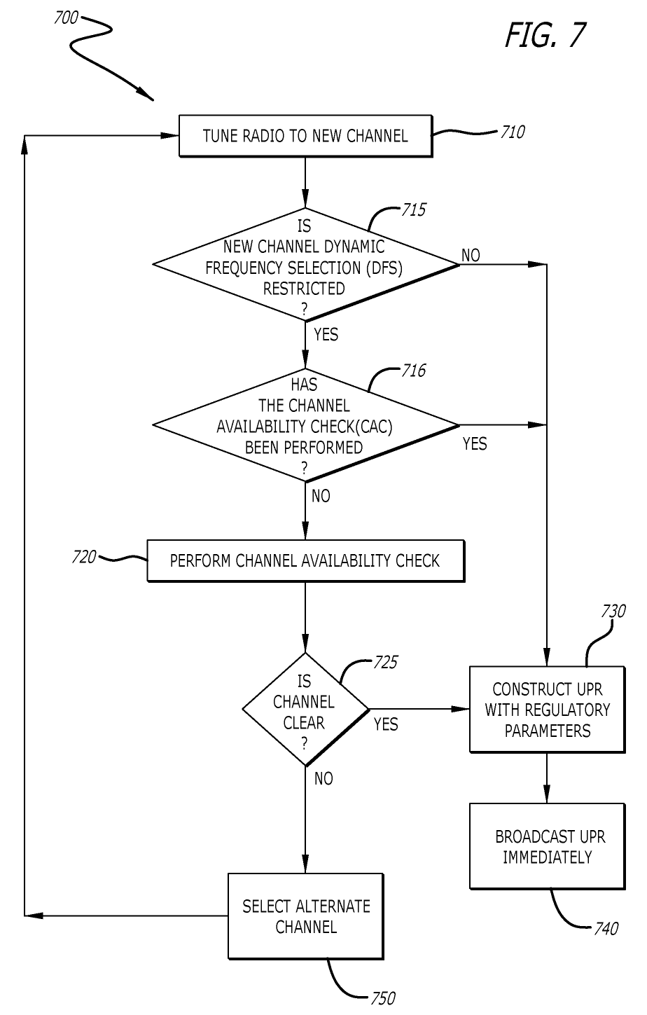

Referring to FIG. 7, a flowchart depicting a process 700 for access point regulatory checks and frame selection in accordance with various embodiments of the disclosure is shown. The process 700 illustrates the logical sequence for ensuring that a network device complies with frequency–specific transmission requirements before initiating early notifications on a new channel. By integrating these checks into the switching workflow, the channel switch logic can maintain network legality while still striving to minimize client downtime. This method can be particularly relevant when transitioning into frequency bands that share spectrum with radar or other priority incumbents.

In many embodiments, the process 700 can tune radio to new channel (block 710). This operation might involve the channel switch logic reconfiguring the physical layer parameters of a network interface controller to align with a second frequency. For example, the radio might be transitioned from a 2.4 GHz band to a 5 GHz band or a 6 GHz band, or from one channel within 2.4 GHz to another channel within 2.4 GHz, or from one channel within 5 GHz to another channel within 5 GHz, or from one channel within 6 GHz to another channel within 6 GHz. It is contemplated that the tuning process may include a stabilization period to ensure the transmitter and receiver are correctly calibrated for the new medium. For instance, the hardware might perform a self–test or a noise floor measurement immediately after arrival on the second channel. There might be additional hardware or software delays, such as setting up or updating data structures.

In a number of embodiments, the process 700 can determine if the new channel is dynamic frequency selection restricted (block 715). This determination can be made by the channel switch logic based on a stored regulatory database or a region–specific configuration file. If the process 700 determines that the channel is not dynamic frequency selection restricted, then the process 700 can proceed directly to construct unsolicited probe response with regulatory parameters (block 730). However, if it is determined that the new channel is dynamic frequency selection restricted, the process 700 can determine if the channel availability check has been performed (block 716). This can include checking if dynamic frequency selection requirements have been met already, such as by prior scanning using an auxiliary radio. If the channel availability check has already been performed, the process 700 proceeds to block 730. If the check has not been performed, the process 700 can perform channel availability check (block 720). In a non–limiting example, a channel in the 5250–5350 MHz range would typically require such a check to ensure no radar signals are present.

In more embodiments, the process 700 can determine if the channel is clear (block 725). This can involve the channel switch logic monitoring the wireless medium for a specific observation time, such as 60 seconds, to detect any energy signatures corresponding to primary users. If the process 700 has determined that the channel is clear, then the process 700 can construct unsolicited probe response with regulatory parameters (block 730). For example, the channel switch logic can confirm that no pulse patterns matching radar have been identified during the required quiet period. However, if it is determined that the channel is not clear, then some embodiments of the process 700 can select alternate channel (block 750). For instance, if a radar signature is detected, the access point must immediately vacate that specific frequency and choose a different destination.

In further embodiments, the process 700 can construct unsolicited probe response with regulatory parameters (block 730). This construction can involve the channel switch logic generating a management frame that includes updated information such as transmit power control limits or local frequency constraints. For example, if the destination is in a 6 GHz band, the unsolicited probe response might include transmit power control limits obtained from automated frequency coordination data to ensure the device operates within permitted power levels. It is contemplated that the regulatory parameters can be tailored to the specific capabilities of the stations currently associated with the basic service set. For instance, the access point can include specific information elements that inform clients of the maximum allowable bandwidth for the new channel or portions thereof.

In additional embodiments, the process 700 can broadcast unsolicited probe response immediately (block 740). The transmission of this unsolicited probe response can be scheduled as the first action taken by the access point once regulatory compliance is verified. For example, the frame can be sent without waiting for a scheduled beacon interval to provide the earliest possible confirmation of the access point's availability. This immediate broadcast could serve to synchronize the timing synchronization function of all associated stations. In a non–limiting example, the unsolicited probe response can be sent as a broadcast frame to ensure all stations that are ready to receive can receive the necessary connectivity metadata simultaneously.

In still more embodiments, the process 700 can select alternate channel (block 750). This step might be triggered if the original destination channel is found to be occupied by a priority user or is otherwise unsuitable for operation. For example, the channel switch logic can consult a pre–defined list of secondary channels to identify a new target frequency that is likely to be clear. This may include spectrum not subject to rules to protect priority users, or the access point can adopt a mode, such as low power indoor, whereby incumbents do not affect the access point's channel or power selection. Once a new selection is made, the process 700 can once again tune radio to new channel (block 710). It is contemplated that the access point might notify its wireless LAN controller of the change in plans to ensure the entire network infrastructure remains synchronized, or the access point might report the problem to a radio resource management entity which then provides the alternate channel.

Although a specific embodiment for a process 700 for access point regulatory checks and frame selection for carrying out the various steps, processes, methods, and operations described herein is discussed with respect to FIG. 7, any of a variety of systems and/or devices may be utilized in accordance with embodiments of the disclosure. For example, the regulatory checks could be offloaded to a dedicated spectrum management component or a remote cloud service. The elements depicted in FIG. 7 may also be interchangeable with other elements of FIGS. 1–6 and 8–10 as required to realize a particularly desired embodiment.

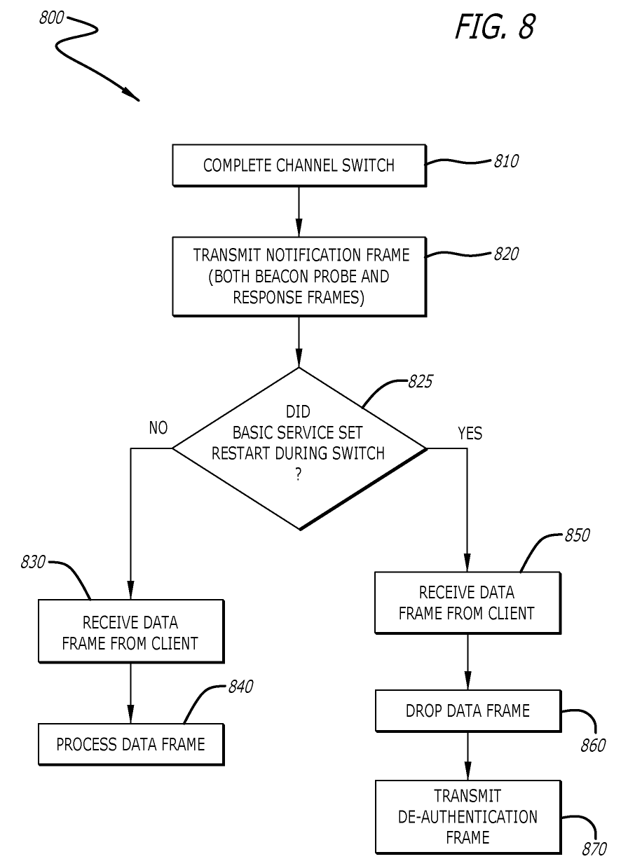

Referring to FIG. 8, a flowchart showing a process for handling client traffic after a channel switch in accordance with various embodiments of the disclosure is shown. The process 800 illustrates the sequence of operations performed by an access point to validate session continuity and manage incoming data frames immediately following a frequency transition. By verifying the state of internal synchronization counters or detecting the absence of previous state information, the process 800 can ensure that stations do not communicate using stale or invalid association parameters. This enforcement mechanism could protect network integrity and facilitate a clean recovery if a system reset occurs during the switching interval.

In many embodiments, the process 800 can complete channel switch (block 810). This completion could involve the channel switch logic verifying that the radio has successfully landed and stabilized on the second channel. For instance, the hardware might signal a successful frequency lock and internal calibration to the serving logic. Alternatively, the completion might be identified by the generation of a ready signal within the firmware of the network device after various hardware and software processes complete. In a non–limiting example, the device might wait for a power stabilizer to confirm that the transceiver is operating within the specified tolerances for the new frequency band.

In a number of embodiments, the process 800 can transmit notification frame (block 820). The notification frame could be an unsolicited probe response that includes updated connectivity metadata and regulatory parameters for the new medium. It is contemplated that the notification might instead be a beacon frame containing a full set of basic service set parameters, especially if the beacon in the normal course of events would be transmitted at or near the switch completion time. For example, the channel switch logic could choose the specific frame type based on the presence of legacy stations that require more comprehensive synchronization data. In some situations, the notification might be transmitted multiple times to ensure that stations in various power–saving states can successfully receive the update.

In more embodiments, the process 800 can determine if the basic service set restarted during the switch (block 825). This determination can be made by the channel switch logic evaluating a specific internal flag or bit that indicates whether a global system reset occurred during the radio retuning period. Because an access point that has reset loses its prior state, it uses its knowledge of the restart itself rather than a comparison of previous timing synchronization function values. If it is determined that the basic service set did not restart during the switch, the process 800 can proceed to block 830. However, if it is determined that the basic service set did restart during the switch, the process 800 can proceed to block 850.

In further embodiments, the process 800 can receive data frame from client (block 830). This frame could be a standard uplink quality of service data frame containing an encrypted payload from a user application. Alternatively, the frame might be a null data frame sent by a station attempting to test the responsiveness of the link after waking up. It is also contemplated that the received frame could be a management frame used to negotiate new transmit power levels on the second channel.

In additional embodiments, the process 800 can process data frame (block 840). This processing might involve the access point successfully decrypting the frame and forwarding the payload to a local area network or the internet. It is contemplated that the processing could include updating the station's activity record to maintain the current association without requiring a new handshake. For example, the channel switch logic might signal to a higher–layer protocol that the data link has been successfully resumed on the new frequency. Alternatively, the process could involve buffering the frame for delivery to a destination that is currently undergoing its own channel transition.

In yet further embodiments, if the basic service set has restarted, the process 800 can receive data frame from client (block 850). Because the access point has reset and effectively forgotten the existence of the client, any frame received from that client will appear as a transmission from an unknown or unauthorized device. Consequently, the process 800 can drop data frame (block 860). The channel switch logic can discard the packet to prevent the processing of data that is out of sync with the current network state. For instance, the device might choose to silently ignore the frame to avoid creating unnecessary traffic on a recently reset link.

In still more embodiments, the process 800 can transmit de–authentication frame (block 870). This frame can be sent to the station to formally terminate the stale authentication and signal that a full re–association procedure is required. Often, the de–authentication or disassociation frame includes a reason code indicating that the session is no longer valid because the access point has restarted its internal clocks. By transmitting this frame, the channel switch logic ensures the station is notified of the logical misalignment, prompting the station to update its own synchronization parameters to match the new network instance.

Although a specific embodiment for a process 800 for handling client traffic after a channel switch for carrying out the various steps, processes, methods, and operations described herein is discussed with respect to FIG. 8, any of a variety of systems and/or devices may be utilized in accordance with embodiments of the disclosure. For example, the traffic enforcement and timestamp validation could be offloaded to a separate security processor or a centralized controller. The elements depicted in FIG. 8 may also be interchangeable with other elements of FIGS. 1–7 and 9–10 as required to realize a particularly desired embodiment.

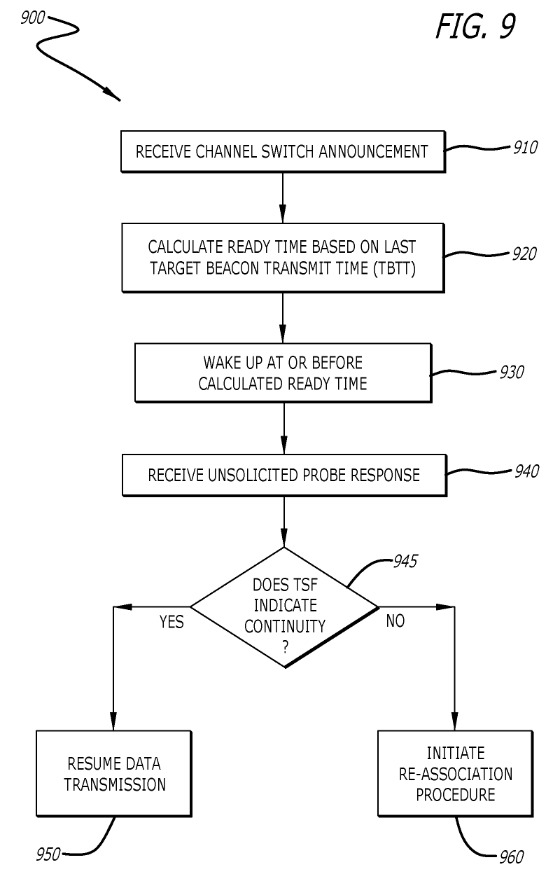

Referring to FIG. 9, a flowchart showing a process 900 for station wake up and synchronization verification in accordance with various embodiments of the disclosure is shown. The process 900 illustrates the logical sequence executed by a wireless device to utilize redefined timing parameters and resume connectivity efficiently after an access point transitions to a new frequency. In some embodiments, the station can calculate a precise ready time to minimize power consumption. In other embodiments, the station can determine a time by which it should be awake, such as approximately one beacon interval before the indicated switch time, to ensure it is ready to receive an unsolicited probe response. By being awake to receive the unsolicited probe response, the station can avoid the latency associated with legacy beacon schedules and begin communicating immediately once the serving access point becomes available. This client side logic ensures that the device remains ready to communicate with the network as soon as the serving access point is ready again, even during complex reconfigurations.

In many embodiments, the process 900 can receive one or more channel switch announcement(s) (block 910). This announcement(s) might be received by the station while it is associated with a first frequency and can contain a max channel switch time element. For instance, the channel switch logic can extract a numerical value from a switch time field that represents the duration from a reference point until the access point is ready for service on a destination channel. The reference point might be the TBTT of the last beacon of the old channel. Alternatively, the station might receive the announcement on a second link in a multi-link operation, informing it of a pending or ongoing change on a first link. It is contemplated that the station could use the information in the announcement to prepare its own hardware and software for a frequency transition.

In a number of embodiments, the process 900 can calculate a ready time or a related parameter based on a last target beacon transmit time (block 920). This parameter can include the scheduled transmission time for an unsolicited probe response, the time by which the access point will surely have transmitted the unsolicited probe response, or the time by which the access point will have transmitted its first beacon on the second channel. The calculation can involve the channel switch logic identifying the stable timestamp of the most recent beacon received on the first channel. Because the channel switch announcement may be transmitted across multiple frames leading up to the transition, for example, from the sixth–last beacon through the final beacon on the old channel, the logic translates the received timestamp to the target beacon transmit time of the absolute last beacon to be sent on the first channel.

The station can then add the duration specified in the channel switch announcement to this reference time to align its internal timer with the intended ready point of the access point. For a next–generation station, this may involve targeting a wake–up time approximately one beacon interval before the indicated time to monitor for an unsolicited probe response. It is also contemplated that the station can factor in its own hardware and software transition delays when determining the optimal moment to begin its wake–up sequence. In a non–limiting example, a station might adjust the calculated time to account for the duration required for its own radio to stabilize on the second channel. If the station determines it is slower than the access point, the station can plan to wait for the first beacon, snoop for other traffic from the access point, or use a conservative transmit power, such as world–mode, to probe the access point and receive a solicited probe response.

In more embodiments, the process 900 can wake up at or by the calculated ready time (block 930). In various embodiments, this may include waking up one beacon interval or thereabouts beforehand. This operation involves the station transitioning its wireless interface from a low power doze or sleep state to an active state to listen for incoming management frames. In certain embodiments, the channel switch logic can schedule the radio to become operational exactly when the access point is expected to reach its ready state.

Alternatively, in embodiments where the indicated switch time points to a guaranteed beacon transmission for legacy compatibility, the station can be configured to wake up ahead of time to be ready for an unsolicited probe response. By waking up one beacon interval before the indicated deadline, the station ensures it is ready to receive the unsolicited probe response as soon as it appears, rather than waiting for the later beacon. This proactive wake up allows the station to bypass a significant portion of the dead time interval found in legacy switching behaviors. It is contemplated that the station might initially wake up in a receive only mode to conserve energy while waiting for the first signaling frame on the second channel.

In further embodiments, the process 900 can receive an unsolicited probe response or the first beacon frame on the second channel (block 940). This operation involves the station listening for the earlier of the unsolicited probe response and the first scheduled beacon to determine access point readiness. While the access point can broadcast an unsolicited probe response immediately upon arrival and completion of regulatory checks, it may instead transmit only a beacon frame if its readiness occurs at or near the target beacon transmit time. The station can parse whichever frame is received first to extract updated connectivity metadata, such as new transmit power limits or frequency–specific regulatory constraints. For example, the unsolicited probe response or the beacon frame can confirm that the access point has successfully passed its channel availability checks and is available for data traffic, providing the necessary synchronization parameters to re–establish the link.

In additional embodiments, the process 900 can determine if the time synchronization function (TSF) indicates continuity (block 945). This determination can be made by analyzing the timestamp within the received management frame and comparing it to the station's internal timer. If the process 900 has determined that the time synchronization function indicates continuity, then the process 900 can resume data transmission (block 950). However, if it is determined that the time synchronization function does not indicate continuity, then some embodiments of the process 900 can initiate association or re-association procedure (block 960). The channel switch logic could check for a specific flag or a large temporal jump (back in time) or a TSF value close to 0 or within the max channel switch time advertised by the AP that would suggest the access point has reset its internal clocks. In a non-limiting example, if the received timestamp is near zero while the station expected a value continuing from the old channel, the station might conclude that the session state has been lost.

In still more embodiments, the process 900 can resume data transmission (block 950). This resumption can occur immediately after the station verifies that its association state remains valid and synchronized with the access point. For instance, the channel switch logic can notify higher-layer applications that the link is restored, and that buffered data can now be transmitted. It is contemplated that the station could immediately send an acknowledgment or a null data frame to the access point to confirm its presence on the new channel. In a non-limiting example, a video conferencing application might resume sending packets without the user perceiving any significant interruption in the stream. In another embodiment, the client never notifies upper layers of the interruption given its brief nature, and so upper layers do not pause and/or resume and rather the client’s Wi-Fi subsystem just attempts to deliver buffered video conferencing frames as fast as possible, and also receive delayed video conferencing frames and deliver them to its upper layers as fast as possible,

In yet further embodiments, the process 900 can initiate association or re-association procedure (block 960). This procedure can be triggered if the station detects that the basic service set has undergone a reset or if the access point sends a de-authentication frame. The station can then perform a full handshake, including authentication and association requests, to establish a fresh connection with the network infrastructure. Often, this includes renegotiating capabilities and security keys to align with the new network instance. It is contemplated that the station might also perform a fresh scan of the frequency band if the intended access point is no longer reachable after the switch.

Although a specific embodiment for a process 900 for station wake up and synchronization function verification for carrying out the various steps, processes, methods, and operations described herein is discussed with respect to FIG. 9, any of a variety of systems and/or devices may be utilized in accordance with embodiments of the disclosure. For example, the timing calculations and wake-up scheduling could be managed by a dedicated power management controller or a secondary low-power processor. The elements depicted in FIG. 9 may also be interchangeable with other elements of FIGS. 1–8 and 10 as required to realize a particularly desired embodiment.

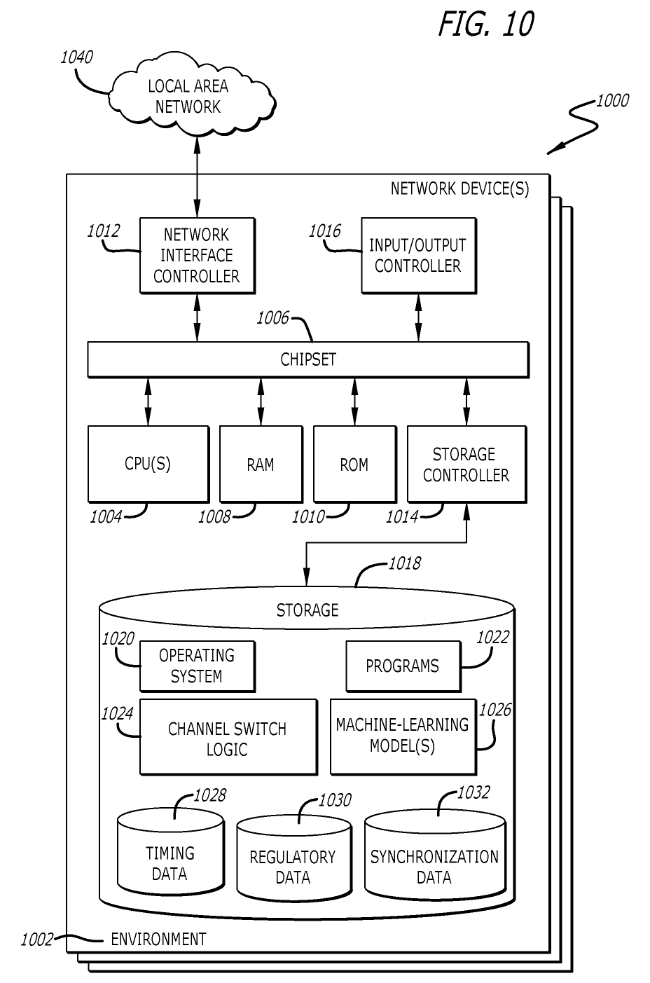

Referring to FIG. 10, a conceptual block diagram of a device 1000 suitable for configuration with a channel switch logic 1024 for implementing the functionality and various embodiments of the disclosure is shown. The embodiment of the device 1000 in the conceptual block diagram depicted in FIG. 10 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1000 may, in some examples, correspond to a physical device or to a virtual resource described herein. The device 1000 can be a network device, for example, an access point, a router, a switch, any type of edge-based network device, a server, a system, or the like in accordance with various embodiments of the disclosure.

In many embodiments, the device 1000 may include an environment 1002, which may represent the overall operational context or physical assembly, such as a baseboard or a motherboard, in physical embodiments that can be configured as a printed circuit board with a multitude of components or devices connected by way of a system bus or other electrical communication paths.

Conceptually, in virtualized embodiments, the environment 1002 may be a virtual environment that encompasses and executes the remaining components and resources of the device 1000. In a number of embodiments, CPU(s) 1004 such as, but not limited to, Central Processing Units, can be configured to operate in conjunction with a chipset 1006. The CPU(s) 1004 can be standard programmable CPUs that perform arithmetic and logical operations that may support the operation of the device 1000.

In a variety of embodiments, the CPU(s) 1004 can perform one or more operations by transitioning from one discrete, physical state to the next through the manipulation of switching elements that differentiate between and change these states. Switching elements generally can include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 1006 may provide an interface between the CPU(s) 1004 and the remainder of the components and devices within the device 1000. The chipset 1006 can provide an interface to a Random-Access Memory (RAM 1008), which can be utilized as the main memory in the device 1000 in some embodiments.

The chipset 1006 can further be configured to provide an interface to a computer-readable storage medium such as a Read-Only Memory (ROM 1010) or a Non-Volatile RAM (NVRAM) for storing basic routines that can help with various tasks such as, but not limited to, starting up the device 1000 and/or transferring information between the various components and devices. The ROM 1010 or NVRAM can also store other application components that may support the operation of the device 1000 in accordance with various embodiments described herein.

Different embodiments of the device 1000 can be configured to operate in a networked environment using logical connections to remote computing devices and computer systems through a network, such as the local area network 1040. The chipset 1006 can include functionality for providing network connectivity through a network interface controller 1012 (or NIC), which may include a gigabit Ethernet adapter, a high-speed SerDes interface, or similar component. The network interface controller 1012 can be capable of connecting the device 1000 to other devices over the local area network 1040. It is contemplated that a network interface controller 1012, or multiple, may be present in the device 1000, connecting the device 1000 to other types of networks and remote systems.

The device 1000 may also include other device(s) (not explicitly numbered but implied as connected to the input/output controller 1016 or system bus). In more embodiments, the device 1000 can be connected to a storage 1018 that provides non-volatile storage for data accessible by the device 1000. The storage 1018 can, for example, store an operating system 1020, applications or programs 1022, timing data 1028, regulatory data 1030, and synchronization data 1032, which are described in greater detail below. The storage 1018 can be connected to the main system components through a storage controller 1014 connected to the chipset 1006 or system bus.

In additional embodiments, the storage 1018 can include one or more physical storage units. The storage controller 1014 can interface with the physical storage units through interfaces such as a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units. The device 1000 can store data within the storage 1018 by transforming the physical state of the physical storage units to reflect the information being stored. The specific transformation of the physical state can depend on various factors. Examples of such factors can include, but are not limited to, the technology utilized to implement the physical storage units, whether the storage 1018 is characterized as primary or secondary storage, and the like. For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like.

Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units. In addition to the storage 1018 described above, the device 1000 can have access to other computer-readable storage media to store and retrieve information, such as program modules, data structures, or other data.

It should be appreciated by those skilled in the art that computer-readable storage media is any available media that provides for the non-transitory storage of data and that can be accessed by the device 1000. In some examples, the operations performed by a cloud computing network, and/or any components included therein, may be supported by one or more devices similar to the device 1000. Stated otherwise, some or all of the operations performed by a cloud computing network, and/or any components included therein, may be performed by the device 1000 operating in a cloud-based arrangement. By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1018 can store an operating system 1020 utilized to control the operation of the device 1000. According to one embodiment, the operating system 1020 includes the LINUX operating system. According to another embodiment, the operating system 1020 includes the Windows server operating system from Microsoft Corporation. According to further embodiments, the operating system 1020 can include the UNIX operating system or one of its variants. It should be appreciated that other operating systems can also be utilized. The storage 1018 can store other system or application programs and data utilized by the device 1000.

In still more embodiments, the storage 1018 or other computer-readable storage media is encoded with computer-executable instructions which, when loaded into the device 1000, may transform the device 1000 from a general-purpose computing system into a special-purpose computer capable of implementing the embodiments described herein. These computer-executable instructions may be stored as applications or programs 1022 and transform the device 1000 by specifying how the CPU(s) 1004 can transition between states, as described above. In still further embodiments, the device 1000 has access to computer-readable storage media storing computer-executable instructions which, when executed by the device 1000, perform the various processes described with regard to the flowcharts of the present disclosure. In still additional embodiments, the device 1000 can also include computer-readable storage media having instructions stored thereupon for performing any of the other computer-implemented operations described herein.

In some more embodiments, the device 1000 can also include one or more input/output controller 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device.

Those skilled in the art will recognize that the device 1000 may not include all of the components shown in FIG. 10, and can include other components that are not explicitly shown in FIG. 10, or may utilize an architecture completely different than that shown in FIG. 10. As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

The channel switch logic 1024, in various embodiments, may represent a dedicated hardware circuit, a programmable logic device, a set of instructions executed by CPU(s) 1004, or a combination thereof, within the device 1000. This channel switch logic 1024 can be configured to manage and regulate the frequency transitions of the wireless transceivers, particularly the timing and signaling involved in moving from a first channel to a second channel. It is contemplated that channel switch logic 1024 can implement processes for determining that a switch is needed, calculating a precise ready time, and scheduling the transmission of immediate management frames on the new frequency, as described in various embodiments of the disclosure.

In some embodiments, the channel switch logic 1024 can implement specific algorithms for constructing the payload of an unsolicited probe response to notify stations of access point availability. This might involve collecting real-time information about the access point readiness state and the stability of the physical layer hardware after a retuning event. The channel switch logic 1024 can then verify that any required regulatory checks, such as radar detection, have been successfully completed. By coordinating these actions, the channel switch logic 1024 ensures that the notification frame is broadcast at the earliest legally permissible moment.

In certain embodiments, the channel switch logic 1024 can actively monitor inputs such as timing data 1028, regulatory data 1030, and synchronization data 1032 to make informed adjustments. This monitoring allows the logic to adapt the switching sequence based on current network congestion or the specific capabilities of associated stations. The channel switch logic 1024 can analyze these data streams to predict the optimal moment for waking up dozing clients. By processing this information in real-time, the logic can maintain high efficiency throughout the channel transition process.

For example, if timing data 1028 indicates a specific last target beacon transmit time, or if regulatory data 1030 signals that a target channel requires a channel availability check, the channel switch logic 1024 might adjust the calculated value of the switch time field. This could involve modifying the parameters of the immediate management frame to account for the additional duration of the required spectrum monitoring. By anticipating these needs, the logic can ensure that all associated stations are correctly synchronized and aware of the precise ready point.

Similarly, based on synchronization data 1032, the channel switch logic 1024 could implement session recovery techniques to maintain the integrity of the network connections across varying operating conditions within the device 1000. The logic can determine whether a de-authentication frame is necessary to alert stations that the basic service set has restarted. By ensuring that client and access point clocks remain aligned, the channel switch logic 1024 minimizes the disruption caused by resets. These operations facilitate a stable and responsive wireless environment even during frequent frequency reconfigurations.

The machine-learning model(s) 1026, in some embodiments, may represent a computational engine or a set of algorithms configured to learn from data and make predictions or decisions without being explicitly programmed for every specific scenario. This machine-learning model(s) 1026 can be executed by the CPU(s) 1004 or specialized hardware within device 1000 and may interact closely with the channel switch logic 1024. It is contemplated that the machine-learning model(s) 1026 could be trained using timing data 1028 that is historical or simulated, regulatory data 1030, synchronization data 1032, and potentially other system performance metrics. This training allows the model to identify complex patterns and correlations relevant to frequency selection and transition efficiency.

The machine-learning model(s) 1026 can be configured to analyze large datasets to optimize the parameters used by the channel switch logic 1024. This might include predicting the duration of radio retuning based on past performance across different frequency bands. By learning from these historical events, the machine-learning model(s) 1026 can provide more accurate estimations for the ready time field. This predictive capability helps reduce the margin of error in station wake-up schedules.

In certain embodiments, the machine-learning model(s) 1026 can analyze incoming real-time data (timing data 1028, regulatory data 1030, synchronization data 1032) and provide predictive insights or optimized control parameters to the channel switch logic 1024. For example, it might predict impending interference on a candidate channel based on current activity (from regulatory data 1030) and historical noise patterns (from timing data 1028), allowing the channel switch logic 1024 to take proactive measures. By anticipating these disturbances, the system can maintain a higher quality of service for associated stations.

Furthermore, the machine-learning model(s) 1026 could learn optimal settings for switch time calculations or frame scheduling under various operating conditions. This learning process can enhance responsiveness and session stability as the network load changes. The model might adapt its parameters over time as the physical hardware ages or as environmental noise levels fluctuate. This continuous optimization ensures that the channel transition process remains as efficient as possible.

This approach, leveraging a machine-learning model(s) 1026, can enable more sophisticated, adaptive, and potentially more efficient operation of the channel switch logic 1024 compared to traditional control methods. The ability to refine switching strategies based on observed network behavior allows for a more robust implementation of fast channel switching. By automating the adjustment of complex timing variables, the machine-learning model(s) 1026 reduces the need for manual configuration. This leads to a more autonomous and high-performance wireless local networking system.

The timing data 1028, in various embodiments, may encompass a range of temporal measurements and parameters collected from the network environment or calculated by the device 1000. This data could include, for example, the target beacon transmit time of the last beacon frame or the measured duration of radio retuning. Timing data 1028 might also reflect the final calculated ready time for service on a destination channel. These values are used to define the boundaries of the frequency transition interval.

Timing data 1028 might also include information about the timing synchronization function ticks or intervals between management frames. This granularity is particularly relevant when defining the exact moment associated stations should wake from a doze or sleep state to receive a notification. In environments with dynamic switching, timing data 1028 that is accurate is useful to avoid missing the arrival of an unsolicited probe response. By maintaining precise clock records, the device 1000 can support the rapid resumption of data traffic.

In certain embodiments, the channel switch logic 1024 can utilize timing data 1028 as a key input for its decision-making processes associated with frequency transitions. This input helps the logic determine when to schedule management frames relative to the start of the switching event. By referencing timing data 1028, the system can ensure that all signaled parameters are consistent with the current network state. This alignment is critical for maintaining synchronization across the basic service set.

By analyzing timing data 1028, the channel switch logic 1024 can assess the precise delta between a start reference and the actual availability of the radio infrastructure. This assessment allows the access point to provide stations with a much shorter switch time than what is typically found in legacy systems. The reduction of this delta directly translates into lower latency for end-user applications. Accurate timing analysis thus forms the basis for the improved performance of the switching process.

If timing data 1028 reveals that a transition is taking longer than expected, this information can trigger corrective actions by the channel switch logic 1024. For instance, the logic might update the signaled switch time to prevent stations from waking up too early and wasting power. Conversely, if the hardware retunes faster than predicted, the timing data 1028 allows the system to advance the transmission of the notification frame. This flexibility ensures that the network remains responsive regardless of hardware variability.

The regulatory data 1030, in many embodiments, may represent information pertaining to the legal and operational constraints of different frequency bands or geographic regions accessible by the device 1000. This data can include, but is not limited to, the restriction status for dynamic frequency selection channels. Often, the regulatory data 1030 specifies the required power levels and bandwidth limits for a chosen destination. This ensures that the network device remains in compliance with local spectrum regulations.

Regulatory data 1030 might also reflect current results from channel availability checks or automated frequency coordination services. It could include flags indicating the presence of primary incumbents such as radar signatures in restricted bands. These parameters determine whether a specific channel is legally available for immediate use after a switch. By processing this data, the access point can select the most appropriate frequency for its current operational needs.

It is contemplated that the channel switch logic 1024 can process regulatory data 1030 to anticipate or respond to changes in system conditions that could affect link legality. This might involve checking the status of 6 GHz AFC databases to determine the maximum permitted transmit power. In additional embodiments, this might involve performing a channel availability check before operation at 5 GHz on a DFS channel By staying updated on these constraints, the logic can prevent the transmission of non-compliant frames. This proactive management is essential for operating in complex and highly regulated frequency environments.

For example, if regulatory data 1030 indicates that multiple target channels are restricted, the channel switch logic 1024 might proactively adjust its selection algorithm to favor a non-DFS frequency. This helps handle expected load transiently without incurring the mandatory delays of a full channel availability check. By minimizing the time spent on regulatory verification, the device can restore service more quickly. This context-aware selection process improves the overall efficiency of the network reconfiguration.

Conversely, if regulatory data 1030 shows that many channels have become available due to a lack of radar activity, the logic might adapt its power levels to maximize coverage. The access point can ensure that necessary regulatory parameters are included in the immediate notification frame to inform stations of their new operating limits. This allows associated devices to resume transmission at the highest legal speeds. The use of regulatory data 1030 thus enables more safe and efficient frequency management.

The use of regulatory data 1030 can thus enable more context-aware and efficient frequency management by the channel switch logic 1024. By integrating legal constraints directly into the switching logic, the device avoids the risk of unauthorized transmissions. This robustness is critical for maintaining network certifications and adhering to international standards. Ultimately, this data source supports the deployment of fast-switching technologies across a wide range of regulatory domains.

The synchronization data 1032, in some embodiments, may consist of continuity readings and related information gathered from sensors or internal state monitors within the device 1000. This data might include timestamps from the timing synchronization function gathered at specific intervals. It can provide insights into whether the access point has maintained a continuous session or has undergone a system reset. This information is vital for verifying that client associations remain valid after a frequency move.

Synchronization data 1032 can provide the channel switch logic 1024 with insights into the state of the associated stations and how it might be changing due to varying operational loads. By monitoring the delta between expected and actual timestamps, the logic can detect subtle drifts in the network clock. This allows the system to correct synchronization errors before they impact data throughput. Maintaining accurate session state is a key factor in ensuring a smooth roaming experience.

It is contemplated that the channel switch logic 1024 can utilize synchronization data 1032 to implement session validation schemes or recovery strategies. This might include checking the status of a basic service set reset flag after a hardware retuning event. If a disruption is detected, the logic can use this data to decide whether to resume the current session or force a full handshake. This capability ensures that stations do not attempt to communicate using invalid or stale state information.

Since the logical characteristics of a wireless session can be disrupted by system resets, leading to a loss of session state, the channel switch logic 1024 can use synchronization data 1032 to make corrective adjustments. For instance, if the logic detects that the timing synchronization function has restarted, it can immediately prepare a de-authentication frame for broadcast. This prevents dozing stations from waking up and transmitting data with an incorrect time reference. By enforcing these checks, the system maintains the integrity of the network session.

For example, the channel switch logic 1024 might adjust the contents of an unsolicited probe response based on readings from synchronization data 1032. If the data indicates that continuity has been maintained, the access point can signal that a full re-association is not required. This allows stations to resume their data sessions immediately, significantly reducing the overhead associated with roaming. This optimization helps maintain high performance for real-time applications across varying network conditions.

This can contribute to the overall robustness and reliability of the device 1000. By ensuring that the access point and stations remain logically aligned, the synchronization data 1032 prevents the session failures that often plague frequency transitions. The use of this data source allows for a more controlled and predictable switching process. It ensures that the benefits of fast channel switching are realized without compromising the stability of the wireless connection.

Although a specific embodiment for a device 1000 suitable for configuration with the channel switch logic 1024 for carrying out the various steps, processes, methods, and operations described herein is discussed with respect to FIG. 10, any of a variety of systems and/or processes may be utilized in accordance with embodiments of the disclosure. For example, the channel switch logic 1024 could interface with additional types of sensor data beyond those explicitly shown, or the machine-learning model(s) 1026 could be implemented using a distributed architecture across multiple processing elements within device 1000. The elements depicted in FIG. 10 may also be interchangeable with other elements of FIGS. 1–9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a wireless network; and
a memory communicatively coupled to the processor, wherein the memory comprises a channel switch logic that is configured to:
determine that a channel switch from a first channel to a second channel should occur;
calculate a max channel switch time;
transmit a channel switch announcement;
switch at least one radio to the second channel; and
schedule for transmission an unsolicited management frame on the second channel.

2. The device of claim 1, wherein the max channel switch time represents a time delta between a target beacon transmit time of a last beacon frame on the first channel and a time at which the device for service on the second channel.

3. The device of claim 1, wherein the channel switch announcement is transmitted on the first channel.

4. The device of claim 1, wherein the channel switch announcement further includes the calculated max channel switch time.

5. The device of claim 1, wherein the transmission of the unsolicited management frame is enqueued for transmission immediately upon being ready for service.

6. The device of claim 1, wherein the unsolicited management frame is configured to notify at least one station of availability.

7. The device of claim 1, wherein the unsolicited management frame is scheduled for transmission prior to a next scheduled target beacon transmit time on the second channel.

8. The device of claim 1, wherein the unsolicited management frame includes at least one regulatory parameter corresponding to the second channel.

9. The device of claim 1, wherein the channel switch logic is further configured to transmit a de-authentication frame to a station in response to determining that a time synchronization function reset during the channel switch.

10. The device of claim 1, wherein the channel switch logic is further configured to transmit information regarding the channel switch on a third channel through a second access point affiliated with a same multi-link device as the device.

11. A wireless device, comprising:
a processor;
a wireless interface configured to communicate with an access point; and
a memory communicatively coupled to the processor, wherein the memory comprises a channel switch logic that is configured to:
receive, from the access point, a channel switch announcement indicating a switch from a first channel to a second channel;
calculate a ready time for the second channel;
transition the wireless interface to the second channel to wake up at the calculated ready time;
receive an unsolicited management frame from the access point on the second channel; and
resume data transmission.

12. The wireless device of claim 11, wherein the wireless interface is transitioned to the second channel prior to the calculated ready time.

13. The wireless device of claim 11, wherein the channel switch announcement comprises a max channel switch time element.

14. The wireless device of claim 13, wherein the ready time for the second channel is calculated based on a last target beacon transmit time on the first channel.

15. The wireless device of claim 14, wherein the ready time for the second channel is also calculated based on a switch time field within the max channel switch time element.

16. The wireless device of claim 15, wherein, prior to resuming data transmission, the channel switch logic is further configured to:
verify a continuity of a time synchronization function based on the unsolicited management frame; and
resume the data transmission in response to the time synchronization function indicating continuity from the first channel.

17. A method of efficient channel switching, comprising:
determining, by an access point, that a channel switch from a first channel to a second channel should occur;
calculating, by the access point, a max channel switch time;
transmitting a channel switch announcement;
switching at least one radio of the access point to the second channel; and
scheduling for transmission, by the access point, an unsolicited management frame on the second channel.

18. The method of claim 17, further comprising performing a channel availability check on the second channel prior to scheduling the unsolicited management frame for transmission.

19. The method of claim 17, wherein the unsolicited management frame is a broadcast unsolicited probe response frame that includes a time synchronization function value indicating that the access point has not restarted.

20. The method of claim 17, further comprising receiving a data frame from a station on the second channel after the transmission of the unsolicited management frame and processing the data frame without requiring a fresh authentication.
